(19) United States
(12) Patent Application Publication
(10) Pub. No.: US 2024/0277564 A1
(43) Pub. Date: Aug. 22, 2024

(54) Cupping Device, System, and Features

(71) Applicant: Cynthia R. Brown, Chapel Hill, NC (US)

(72) Inventor: Cynthia R. Brown, Chapel Hill, NC (US)

(21) Appl. No.: 18/438,418

(22) Filed: Feb. 10, 2024

Related U.S. Application Data
(60) Provisional application No. 63/446,055, filed on Feb. 16, 2023.

(51) Int. Cl. A61H 23/02

(52) U.S. Cl. CPC A61H 23/02; A61H 2201/01; A61H 2201/10; A61H 2201/1207; A61H 2201/14

(57) ABSTRACT

A suction cup includes a body having a sidewall extending around an interior space and a rim extending around an opening to the cup interior space. At least a portion of the body is elastic and configured so that the body is capable of being squeezed to transition the body from an at-rest configuration to a partially-collapsed configuration, and elastically biased toward the at-rest configuration. The volume of an interior space of the cup of the body is greater in the at-rest configuration than in the partially-collapsed configuration. The rim is less stiff than a portion of the sidewall that is spaced apart from the rim. The relatively soft rim seeks to provide optimal adhesion to the skin of a user, fortification of at least a portion the body of the cup seeks to better maintain its shape for enhanced ease of use, and other features can be included.

### CROSS-REFERENCE TO PRIORITY APPLICATION

This application claims the benefit of U.S. Provisional Patent Application No. 63/446,055 filed Feb. 16, 2023, which is hereby incorporated by reference in its entirety.

### BACKGROUND

The present invention generally relates to therapy and/or massage equipment and, more particularly, to cupping therapy.

It is known to use a transparent, elastomeric silicone cup for cupping therapy. The cup can be manually partially collapsed, and then the cup can be allowed to elastically expand while the cup's opening is engaged against a user's skin, so that the resulting partial vacuum in the cup causes the cup's opening to be attached to the skin, and suctional force is applied to the skin. The suction on the skin can provide a therapeutic effect.

It is known for suction cups that may be used for cupping therapy to be made of a single homogeneous material, with different cups having different durometers. This can pose difficulties as the stiffer cups may not maintain suction around smaller, narrow, or more rounded body parts, for example forearms. Alternatively, the known softer cups offer more adhesion to the skin but can collapse on themselves rendering them difficult to use as a massage tool.

There is a desire for improvements associated with cupping therapy (e.g., improved ease of use, and improved therapeutic effects).

### SUMMARY

An aspect of this disclosure is the provision of an improved suction cup configured for use in cupping therapy (e.g., massage). The suction cup includes a body including at least one sidewall extending at least partially around an interior space of the cup, and at least one rim extending around an opening to the interior space of the cup. At least a portion of the body can be elastic and configured so that the body is both (i) capable of being squeezed to transition the body from an at-rest configuration to a partially-collapsed configuration, and (i) elastically biased toward the at-rest configuration. The volume of the interior space of the cup is greater in the at-rest configuration than in the partially-collapsed configuration. The rim and/or a closed end of the body can be less stiff than a portion of the sidewall that is spaced apart from the rim. A vibrator, strap, band, over-molded part, under-molded part, insert-molded part, and/or other suitable structure (e.g., stiffening and/or reinforcing structure) can be associated with (e.g., mounted to, embedded in, and/or otherwise associated with) the body of the suction cup.

An example of this disclosure is the provision of a suction cup that has a relatively soft rim (e.g., lip)/open end for optimal adhesion to the user's skin with a fortification (stiffening and/or reinforcing) of the body of the suction cup to better maintain its shape for enhanced ease of use. A vibration apparatus may optionally be included for optimal results. The vibration apparatus can be incorporated into a band that can include at least one inwardly protruding ridge (e.g., a screw thread) for removably mounting the band to the suction cup. The band can be mounted on a relatively rigid mounting surface of the suction cup. The relatively rigid mounting surface can include at least one outwardly extending protrusion (e.g., screw thread) for mating with corresponding structure of the band. One or more relatively rigid extensions can extend from the mounting surface for transmitting vibrations generated by vibration apparatus substantially through at least a lower portion of the body of the suction cup. The suction cup can include one or more ridges or other suitable protrusions proximate the rim for supporting the rim and/or engaging a user's tissue for enhancing the therapeutic massage effect. The suction cup can include, or otherwise be associated therewith, one or more light emitting diodes or other suitable emitters for emitting light, red light, and/or infrared radiation that impinges upon the portion of the user's skin that is undergoing suction therapy for enhancing the therapeutic effect.

The foregoing summary provides a few brief examples and is not exhaustive, and the present invention is not limited to the foregoing examples. The foregoing examples, as well as other examples, are further explained in the following detailed description with reference to accompanying drawings.

### BRIEF DESCRIPTION OF THE DRAWINGS

The drawings are provided as examples, and they are schematic and may not be drawn to scale. The present invention may be embodied in many different forms and should not be construed as limited to the examples depicted in the drawings.

FIG. 1 is a top, front pictorial view of a therapeutic system including a vibration apparatus mounted to a suction cup, wherein the suction cup is depicted in its at-rest configuration, in accordance with a first embodiment of this disclosure.

FIG. 2 is an isolated, front elevation view of the suction cup of FIG. 1 in its at-rest configuration, wherein FIG. 2 is also representative of right, left, and rear elevation views of the suction cup of FIG. 1.

FIG. 3 is an isolated, top plan view of the suction cup of FIG. 1 in its at-rest configuration.

FIG. 4 is a cross-sectional view taken along line 4-4 of FIG. 3 (i.e., the cutting plane defining FIG. 4 intersects the entire length of the lengthwise axis of the suction cup), wherein FIG. 4 further schematically depicts that a housing and/or any other stiffening features may be embedded in the body of the suction cup.

FIG. 5 is a cross-sectional view of at least a portion of a mold assembly that may be used in the manufacture of the suction cup, wherein the mold is in its closed configuration, and the cutting plane defining FIG. 5 intersects the entire length of the lengthwise axis of the closed mold, in accordance with the first embodiment.

FIG. 6 is an exploded, front pictorial view of a therapeutic system in accordance with a second embodiment of this disclosure.

FIG. 7 is another cross-sectional view taken along line 4-4 of FIG. 3, wherein FIG. 7 schematically depicts by way of contrasting cross hatching that the suction cup may be at least partially manufactured, for example, by way of over molding, in accordance with a third embodiment of this disclosure.

FIG. 8 is further cross-sectional view taken along line 4-4 of FIG. 3, wherein FIG. 8 schematically depicts by way of contrasting cross hatching that the suction cup may be at least partially manufactured, for example, by way of over molding, in accordance with a fourth embodiment of this disclosure.

FIG. 9 depicts an example of suction cups of this disclosure arranged in or otherwise associated with a tray or other suitable container, a charging station, and/or the like, wherein the suction cups can be operatively associated with at least one computerized device that can be spaced apart from the suction cups.

FIG. 10 is an exploded view of a therapeutic system including a suction cup and a band configured to be removably mounted to the suction cup, in accordance with a fifth embodiment of this disclosure.

FIG. 11 depicts an example of the band of FIG. 10 being mounted to the suction cup of FIG. 10.

FIG. 12 depicts the therapeutic system of FIG. 10 in an assembled configuration.

FIG. 13 is a front elevation view of a suction cup in accordance with a sixth embodiment of this disclosure.

FIG. 14 is a cross-sectional view taken along line 14-14 of FIG. 13.

FIG. 15 is an isolated, top, front pictorial view of a band configured to be removably mounted to a suction cup, in accordance with a seventh embodiment of this disclosure.

FIG. 16 is an isolated, front elevation view of a suction cup of the seventh embodiment.

FIG. 17 is a partially cut-away view depicting a therapeutic system including the band of FIG. 15 and the suction cup of FIG. 16 in an assembled configuration.

FIG. 18 is a front elevation view of a suction cup in accordance with a variation of the seventh embodiment.

FIG. 19 is a top, side pictorial view of a suction cup in accordance with an eighth embodiment.

FIG. 20 is a cross-sectional view taken substantially or generally along line 20-20 of FIG. 19.

FIG. 21 is a bottom, side pictorial view of a suction cup in accordance with a ninth embodiment.

FIG. 22 is a side cross-sectional view taken substantially along line 22-22 of FIG. 21.

FIG. 23 is a side cross-sectional view of a suction cup in accordance with a variation of the ninth embodiment.

FIG. 24 is a bottom plan view of the suction cups of FIGS. 21-23.

FIG. 25 is a bottom plan view of a suction cup in accordance with a variation of the ninth embodiment.

FIG. 26 is a bottom, side pictorial view of the suction cup of FIG. 25.

FIG. 27 is a side cross-sectional view of a suction cup in accordance with a tenth embodiment.

FIG. 28 is a bottom plan view of the suction cup of FIG. 27.

FIG. 29 is a side cross-sectional view of a suction cup in accordance with a variation of the tenth embodiment.

FIG. 30 is a bottom plan view of the suction cup of FIG. 29.

### DETAILED DESCRIPTION

Examples of embodiments are disclosed in the following. The present invention may, however, be embodied in many different forms and should not be construed as limited to the embodiments set forth herein. For example, features disclosed as part of one embodiment or example can be used in the context of another embodiment or example to yield a further embodiment or example. As another example of the breadth of this disclosure, it is within the scope of this disclosure for one or more of the terms “substantially,” “about,” “approximately,” and/or the like, to qualify each of the adjectives and adverbs of the Detailed Description section of disclosure, as discussed in greater detail below. Like reference numerals denote like, or at least similar, elements throughout the attached drawings and the Detailed Description section of this disclosure.

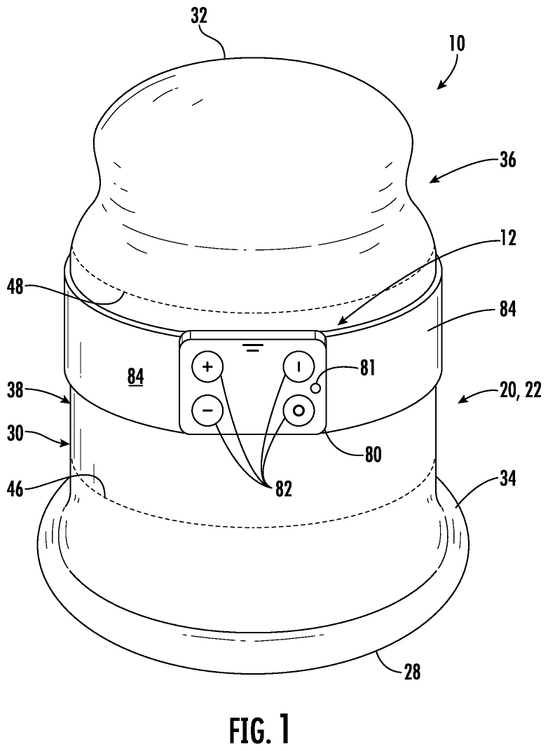

FIG. 1 schematically depicts a therapeutic system 10 that includes a vibration apparatus 12 mounted to a suction cup 20, in accordance with a first embodiment of this disclosure. The first embodiment suction cup 20 is configured (e.g., is at least partially collapsible and elastomeric) so that it can be used for cupping therapy (e.g., massage). More specifically, the suction cup 20 can be manually operated to create a partial vacuum that is used to removably mount the suction cup on the skin of a user, and apply a suctional force to the skin (not depicted in the drawings). The vibration apparatus 12 can be mounted or otherwise located at any suitable position along the length of the suction cup 20, as discussed further below. The vibration apparatus 12 can be referred to as an accessory that is not required for use of the suction cup 20.

The optional vibration apparatus 12 can be operated during the cupping therapy in a manner that vibrates each of the suction cup 20, the associated skin, and underlying tissue (e.g., tendon(s)) in a manner that enhances the therapeutic effects of the cupping therapy. It is believed that the added vibrations aid in blood flow and aid in breaking up (e.g., releasing) tissue adhesions. The vibration apparatus 12 may be a permanent part of the suction cup 20, or it may optionally be added to the suction cup as an accessory. For example, the vibration apparatus 12 can be removably mounted to the suction cup 20, as discussed further below. As an example, the vibration apparatus 12 may be characterized as being a part of the suction cup 20.

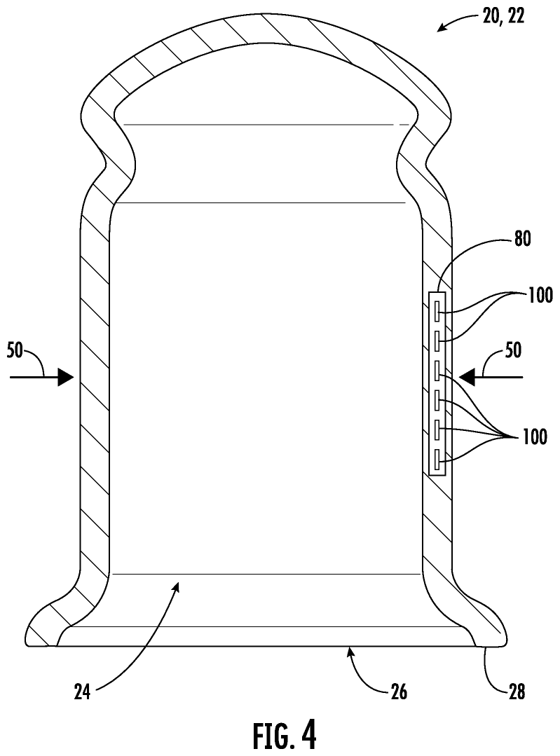

Referring also to FIG. 4, the suction cup 20 can comprise, consist essentially of, or consist of a deformable, container-shaped body 22 that defines an interior space 24 (FIG. 4) of the suction cup. In the first embodiment, the cup interior space 24 is only open at a single opening 26 (FIG. 4) defined by at least one rim 28 (e.g., an annular rim) of the body 22. The rim 28 is configured to be engaged against the user's skin, so that the user's skin closes the opening 26. FIG. 4 can be further described as schematically depicting that the body 22, or more specifically the at least one sidewall 30 of the body, can include one or more embedded fortifying (e.g., reinforcing and/or stiffening) elements or features, as may be generally understood with reference to the feature identified by reference numeral 80 in FIG. 4, and as discussed further below.

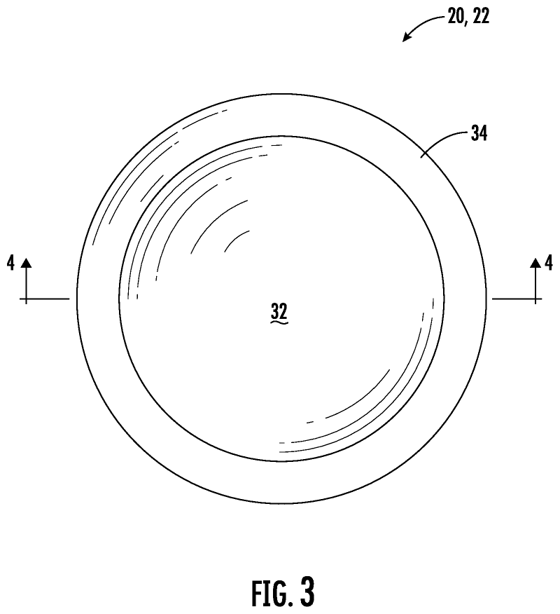

The first embodiment body 22 comprises, consists essentially of, or consists of elastomeric material so that the cup 20 can be manually squeezed to transition the body from an at-rest configuration (FIGS. 1-4) to an initial partially-collapsed configuration (not depicted in the drawings). The cup 20 is configured so that, allowing the body 22 to transition from the initial partially-collapsed configuration toward the at-rest configuration (e.g., by ceasing the manual squeezing, and in response to the body being elastically biased toward the at-rest configuration), while the rim 28 is engaged against skin that closes the opening 26, a partial vacuum is created in the cup interior space 24. As a result, suctional force is applied to the skin, and the opening 26 and/or rim 28 are attached to the skin (e.g., the suction cup 20 is removably mounted to the skin).

Depending upon the configuration and properties of the suction cup 20 and the tissue to which the cup is mounted, the cup may not reach the at-rest configuration when the cup is mounted to the skin as discussed above. That is, the combination of the cup 20 mounted to the skin may reach an equilibrium configuration in which the cup is in an intermediate partially-collapsed configuration that is between its at-rest configuration and the initial partially-collapsed configuration. That is, the degree to which the cup 20 is collapsed is greater in the initial partially-collapsed configuration than in the intermediate partially-collapsed configuration. The volume of the cup interior space 24 is greater in the at-rest configuration than in both of the initial and intermediate partially-collapsed configurations. The volume of the cup interior space 24 is greater in the intermediate partially-collapsed configuration than in the initial partially-collapsed configuration.

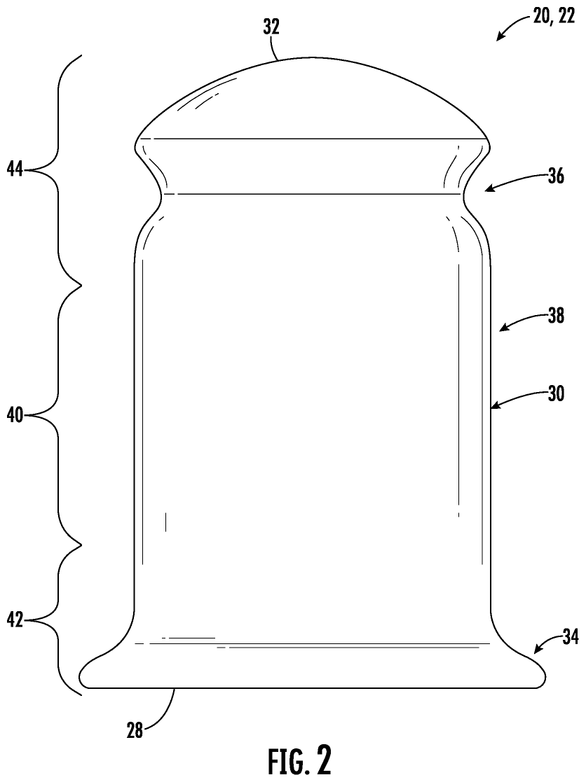

In the orientation of the first embodiment cup 20 depicted in FIGS. 1 and 2, the rim 28 is a lower annular edge of at least one sidewall 30 (e.g., an upright annular sidewall), the sidewall extends upwardly to a domed upper wall 32, and the upper wall fully and permanently closes the upper end of the cup. A lower end portion of the at-rest sidewall 30 can be in the form of smoothly shaped, outwardly extending, annular flange 34 portion that includes the rim 28. An upper portion of the at-rest sidewall 30 can be in the form of smoothly shaped, annular undulated wall portion 36 (e.g., an annular pleat-like or bellows-like portion). An intermediate portion of the at-rest sidewall 30 can be in the form of a cylindrical wall portion 38 that connects the end portion or flange 34 to the undulated wall portion 36 (e.g., a recess that can be in the form of an annular groove). As depicted in FIGS. 1 and 2, an upper annular portion of the undulated wall portion 36 (e.g., groove) can be connected to an outer annular portion of the upper wall 32.

Referring to FIG. 2, the first embodiment cup body 22 includes an intermediate portion 40 between opposite open and closed end-portions 42, 44 of the cup body. In FIG. 1, the boundary 46 between the body's intermediate portion 40 and the body's lower, open end-portion 42 is schematically depicted by a lower dashed boundary line 46; and the boundary 48 between the intermediate portion 40 and the upper, closed end-portion 44 is schematically depicted by an upper dashed boundary line 48. In accordance with an example of a method of using the cup 20 for cupping therapy, the step of partially collapsing the body 22 comprises a user manually squeezing the intermediate portion 40 with one of their hands, between their thumb and fingers, to provide opposite compressive forces schematically depicted in FIG. 4 by arrows 50. The closed end-portion 44 of the cup body 22 may more generally be referred to as an upper end portion of the cup body 22, and it or other portions of the cup body may optionally include one or more openings to the interior space 24 that may be connected to a vacuum pump, have one or more components extend therethrough, or the like.

In the first embodiment, one or more of, or each of, the intermediate portion 40, the open end-portion 42, and the closed end-portion 44 comprises, consists essentially of, or consists of elastomeric material such as silicone; the intermediate portion 40 (e.g., its elastomeric material) is harder and/or stiffer than (e.g., has a higher modulus of elasticity than) the open end-portion 42 (e.g., its elastomeric material); the intermediate portion 40 (e.g., its elastomeric material) is harder and/or stiffer than (e.g., has a higher modulus of elasticity than) the closed end-portion 44 (e.g., its elastomeric material); and the open and closed end-portions 42, 44 (e.g., their elastomeric materials) have about the same hardness and stiffness (e.g., about the same modulus of elasticity). In an alternative embodiment, the intermediate portion 40 and closed end-portion 44 may be formed of the same elastomeric material and have the same hardness, stiffness, and/or modulus of elasticity, such that there may not be a boundary (see, e.g., boundary 48) between the intermediate and closed end-portions 40, 44.

In the first embodiment, the relatively hard and/or relatively stiff material that defines or partially defines the body's intermediate portion 40 can be partially collapsed and then be released to provide a relatively high vacuum that can be maintained during cupping therapy. During cupping therapy in accordance with a method of the first embodiment, the relatively soft and/or relatively flexible material that defines or partially defines the body's closed end-portion 44 allows the closed end-portion to be easily manually manipulated to adjust the vacuum/suction. For example, for adjusting the vacuum/suction during cupping therapy, the domed upper wall 32 can be manually depressed, so that the apex of the domed upper wall moves inwardly relative to the cup interior space 24 (FIG. 4).

During cupping therapy in accordance with a method of the first embodiment, the relatively soft and/or relatively flexible material that defines or partially defines the open end-portion 42 allows a user to relatively easily glide the rim 28 across their skin and/or around curved portions of their body without losing suction. For example, the rim 28 can be guided around curves of the user's arms for treating tendonitis. For promoting easy gliding, bath water, shower water, and or lubricants (e.g., oils) may be present on the skin. Accordingly, the system 10, or respective components thereof, may be waterproof, readily cleanable, and/or the like. Differently sized cup bodies 22 can be used for treating different body parts.

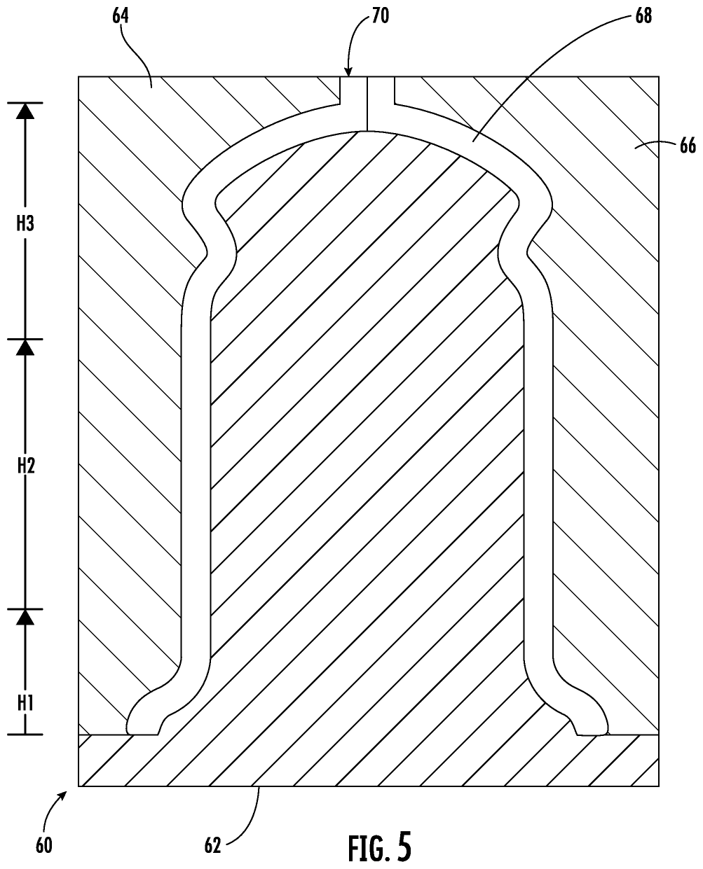

Referring to FIG. 5, it is believed that the first embodiment cup body 22 can be formed (e.g., by way of transfer molding or another suitable molding process) in a mold assembly 60 including at least an inner mold member 62 and opposite outer mold members 64, 66, or the like, at least some of which are movable relative to one another between open and closed configurations. In the closed configuration of the mold 60, a cavity 68 corresponding in shape to the at-rest shape of the cup body 22 is defined between the mold members 62, 64, 66, and the cavity is closed except for being open at one or more access or injection ports 70.

Referring to FIGS. 2 and 5, in accordance with an example of a method of the first embodiment, it is believed that liquid molding material for forming the open end-portion 42 can be introduced into the cavity 68 through the port 70 and/or other suitable port(s) until that liquid molding material reaches a height of H1, then liquid molding material for forming the intermediate portion 40 can be introduced into the cavity 68 through the port 70 and/or other suitable port(s) until that liquid molding material reaches a height of H2, and then liquid molding material for forming the closed end-portion 44 can be introduced into the cavity 68 through the port 70 and/or other suitable port(s) until that liquid molding material reaches a height of H3. In accordance with a method of the first embodiment, it is believed that the liquid molding materials can remain stratified (e.g., substantially, generally, or somewhat stratified) along the boundary lines 46, 48 (FIG. 1), and that cross-linking (curing) can occur in the molding materials of the intermediate portion 40, the closed end-portion 44, and the open end-portion 42 and across the boundary lines 46, 48 so that the opposite lower and upper ends of the intermediate portion 40 are fixedly connected to the open and closed end-portions 42, 44, respectively, and the cup body 22 is a unitary article of manufacture that normally does not include separable parts.

It is believed that the liquid molding material of the open end-portion 42, the intermediate portion 40, and the closed end-portion 44 can be concurrently (e.g., simultaneously) and/or sequentially cross-linked (cured), for example, concurrently and/or sequentially heated to a temperature sufficient to initiate cross-linking (curing). For example, it is believed that the liquid molding material for forming the open end-portion 42, the intermediate portion 40, and the closed end-portion 44 can be introduced into the cavity 68 sequentially as discussed herein and then all together be simultaneously subjected to cross-linking (curing) conditions to form the unitary product. Alternatively, it is believed that the liquid molding material for forming the open end-portion 42 can be introduced into the cavity 68 and then be at least partially cross-linked (cured); thereafter the liquid molding material for forming the intermediate portion 40 can be introduced into the cavity 68 and then be at least partially cross-linked (cured) to fixedly connect the lower end of the intermediate portion 40 to the open end-portion 42; and thereafter the liquid molding material for forming the closed-end portion 44 can be introduced into the cavity 68 and then be at least partially cross-linked (cured) to fixedly connect the upper end of the intermediate portion 40 to the closed end-portion 44. Cross-linking (curing) the molding material of the lower end-portion 42, the intermediate portion 40, and/or the closed end-portion 44 can be completed during and/or after any of the sequential cross-linking (curing) steps.

In accordance with a primary example of the first embodiment (i.e., for example, and not for the purpose of limiting the scope of this disclosure), the cup body 22 can comprise, consist essentially of, or consist of transparent elastic silicone (e.g., crosslinked silicone) that may optionally be colored. In this regard, it is believed that the above-discussed liquid molding materials may each comprise liquid silicone, one or more crosslinking (curing) agents, and one or more other materials (e.g., fillers and/or additives (e.g., colorants)), wherein the amounts and/or types of additives and/or fillers may respectively vary between the portions 40, 42, 44 (FIG. 2) in a manner that causes the properties of the portions 40, 42, 44 to vary in the manner discussed above. Alternatively, the cup body 22 may not be transparent and/or the cup body may be made of other suitable materials, for example polymeric materials that are elastomeric (e.g., rubber).

The cup 20 can include visual indicators or indications for aiding a user of the cup 20. For example, one or more of the boundaries 46, 48 (FIG. 1) may be identified by an actual annular line and/or by adding differently colored colorants (e.g., pigments) to the liquid molding materials respectively for the portions 40, 42, 44 (FIG. 2). The cup 20 can include any suitable colors or color combinations. For example, two or more different cup portions (e.g., portions 40, 42, and/or 44) can be colored differently from one another in a manner that seeks to identify (e.g., by color contrast(s)) to a user the variations in the hardness and/or stiffness of the cup portions. As another example of possible visual indicators or indications for aiding a user of the cup 20, graphics (e.g., images, text, shapes, indicia, patterns, solid areas, or any other printing) may be included on the cup 20. Such visual indicators or indications can seek to help to inform the user how or where to manually manipulate the cup 20 and/or inform the user where to mount the accessorial vibration apparatus 12 (FIG. 1) on the cup.

Referring to FIG. 1, the schematically depicted vibration apparatus 12 can include a housing 80 containing, for example, internal features including a battery that powers an electric motor having a rotary output shaft to which an eccentric mass is connected, and a controller (e.g., computer processer, programmable logic device (PLD), and/or application specific integrated circuit (ASIC), as discussed further below). In one example, the one or more batteries of the vibration apparatus 12, or more specifically the battery(s) carried by or associated with the housing 80, can be configured to be recharged by way of a charging port 81 that receives the free end of a charging cable extending from an external electric power source. Alternatively, the batteries can be recharged by a charging pad, or the like, or in any other suitable manner, as discussed further below. The batteries can be recharged while the vibration apparatus 12 is attached to the cup 20, while the vibration apparatus is detached from the cup, and/or while the batteries are detached from the vibration apparatus. As another example, the batteries may be replaceable. Alternatively, the components described above as being in the housing 80 can be included in other suitable locations, for example within a mounting structure 84 when the mounting structure is in the form of a band, as discussed further below.

The vibration apparatus 12 can include a user interface for allowing a user to control operation of the vibration apparatus. For example, FIG. 1 schematically depicts that such a user interface can include one or more manually-actuatable push-buttons 82 accessible at an outer face of the housing 80. The buttons 82 and/or other suitable features can be operatively associated with the controller for respectively turning the vibration apparatus 12 off and on (e.g., the vibration apparatus vibrates when “on” and does not vibrate when “off”), and increasing or decreasing the strength or energy (e.g., frequency and/or magnitude) of the vibrating. Further, the vibration apparatus 12 can be configured to provide a variety of different vibration waveforms. A variety of differently configured (e.g., differently operable) vibration apparatus 12 are within the scope of this disclosure. For example, the one or more buttons 82 can be arranged in any suitable configuration (e.g., side-by-side in a single row). As further examples, the user interface of the vibration apparatus 12 can include or consist of a manually operatable rocker switch; a touchscreen; a single button that could be operated to power on, cycle through several massage options, and power off; and/or other suitable features. Other features that may be associated with the vibration apparatus 12 are discussed below.

With continued reference to FIG. 1, the vibration apparatus 12 can further include at least one mounting structure 84 in the form of a strap (e.g., band) to which the housing 80 is securely (e.g., fixedly, yet removably) mounted, and the housing can be securely (e.g., fixedly, yet removably) mounted to the cup body 22 by way of the strap. The mounting structure or strap 84 can be a one-piece or two-piece strap connected to the housing 80 in any suitable manner (e.g., by way of one or more bars or slots, fixed bars, spring bars, or the like, that are not depicted in the drawings). For attaching and removing the vibration apparatus 12 from the cup body 22, and adjusting the length of the mounting strap 84 for use with differently sized cup bodies, the strap typically includes and/or is associated with one or more conventional buckles, clasps, and/or length adjustment features that are hidden from view on the far side of the system 10 in FIG. 1.

At least partially reiterating from above, the vibration apparatus 12, if present, can be mounted at any suitable location along the length of the cup 12, and it may typically be mounted at any suitable location along the length of the relatively rigid portion (e.g., the intermediate portion 40) of the cup 12. For example and in contrast to the configuration depicted in FIG. 1, the vibration apparatus 12 can be more proximate or adjacent the boundary 46 between the intermediate and open end portions 40, 42 (FIG. 2). As another example, the vibration apparatus 12 together with the mounting structure 84 (e.g., strap, band, and/or other suitable structure) can be at least partially mounted at or near the undulated wall portion 36 (e.g., groove), as discussed further below. Alternatively, the vibration housing 80 can be associated with (e.g., mounted to, embedded in, and/or otherwise associated with) the cup body 22 in any other suitable manner, as discussed further below.

Referring again to FIG. 1, in an alternative embodiment, the suction cup 20 can be formed of a single and/or uniform type of elastomeric material (e.g., each of the intermediate portion 40, the open end-portion 42, and the closed end-portion 44 comprises, consists essentially of, or consists of a single and/or uniform type of elastomeric material such as silicone). In this embodiment, the intermediate portion 40, the open end-portion 42, and the closed end-portion 44 (e.g., their elastomeric materials) can have about the same hardness and/or stiffness (e.g., about the same modulus of elasticity). To provide a zone (e.g., portion) of the body 22 having a different hardness and/or stiffness as compared to other zones (e.g., other portions) of the body 22, the therapeutic system 10 can further include at least one strap (e.g., band) such as strap 84 (with or without housing 80 as described herein) cooperatively configured with (e.g., mounted to) the intermediate portion 40 of the body 22. The strap 84 can be formed of a material that is harder and/or stiffer than (e.g., has a higher modulus of elasticity than) the elastomeric material of the open end-portion 42, the intermediate portion 40, and the closed end-portion 44. The relatively increased hardness and/or stiffness of the strap 84 can provide a zone of increased stiffness to the body 22. Alternatively, or in addition, the increased hardness and/or stiffness can be attributed to the increased thickness of the portion of the suction cup including both the intermediate portion 40 and the strap 84. As other examples, the strap 84 can be formed of a material that is less hard and/or less stiff (e.g., has a lower modulus of elasticity) as compared to the material of the open end-portion 42, the intermediate portion 40, and/or the closed end-portion 44.

The strap can be detachable (removable). Again, for attaching and removing the strap 84, and adjusting the length of the strap 84 for use with differently sized cup bodies, the strap typically includes and/or is associated with one or more conventional buckles, clasps, and/or length adjustment features that are hidden from view on the far side of the system 10 in FIG. 1.

Numerous variations are within the scope of this disclosure. For example, the cup sidewall 30 may include a greater or lesser number of wall portions (e.g., wall portions 34, 36, 38 of FIG. 1) and/or the cup body 22 may include a greater or lesser number of body portions (e.g., body portions 40, 42, 44 of FIG. 2). For example, the cup 20 may include one or more additional annular grooves and/or undulated wall portions (see, e.g., annular groove and/or undulated wall portion 36), and the vibration apparatus' strap 84 (FIG. 1) may be nested into such an annular groove that functions as a receptacle for at least partially receiving the strap. Additionally or alternatively, the cup 20 can include one or more other features for facilitating mounting or positioning of the vibration apparatus 12 (e.g., an accessory), for example notches, catches, latches, and/or graphics (e.g., images, text, shapes, indicia, patterns, solid areas, or any other printing).

The strap 84 may be referred to as a fortifying (e.g., reinforcing and/or stiffening) element or feature. The strap 84 may be referred to as structure (e.g., a fortification) that is mounted to the cup body 22 and extends at least partially around the cup interior space 24. The strap 84 can be referred to as, or be in the form of, a hoop or band, as discussed further below.

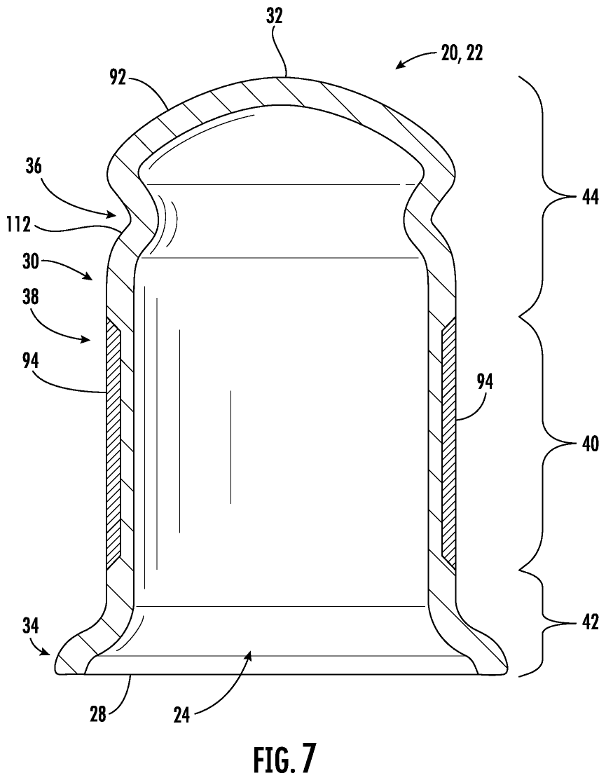

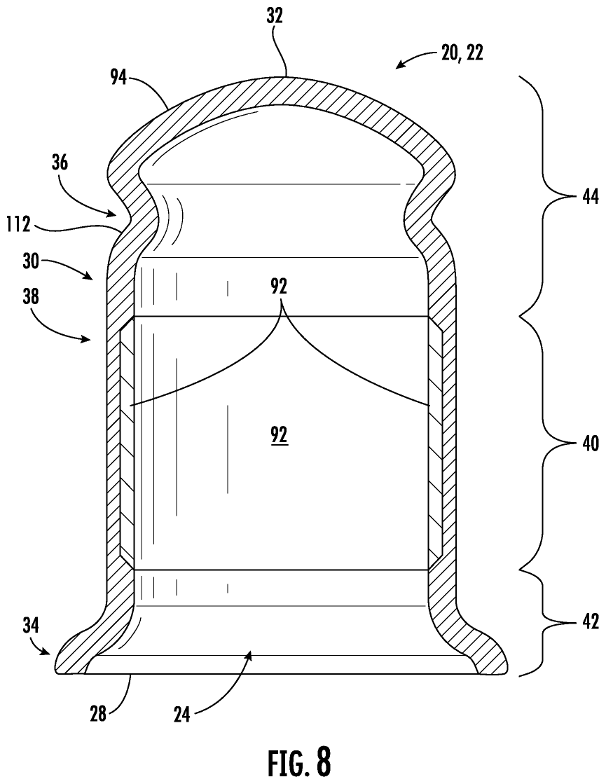

In accordance with an example described above, it is believed that the cup body 22 can be a unitary article of manufacture formed within a single mold 60 assembly (e.g., by way of multi-shot or sequential injection molding). Alternatively, it is believed that one or more portions of the cup body 22 (e.g., one or more of the portions 40, 42, 44 of FIG. 2) can be originally formed separately from one another in any suitable manner (e.g., injection molding, extruding, compression molding, and/or transfer molding) and thereafter be joined together in any suitable manner with connector(s), adhesive(s) (e.g., silicone adhesive), and/or by way of suitable molding techniques (e.g., insert molding, over molding, under molding, or the like) to form the cup body. Reiterating, the cup body 22 of the first embodiment can be at least partially formed by way of over molding, as discussed further below with reference to FIGS. 7 and 8. More generally, it is believed that the cup body 22 can be at least partially formed by way of insert molding, under molding, over molding, and/or in any other suitable manner.

In some embodiments, one or more portions of the cup body 22 (e.g., one or more of the portions 40, 42, 44 of FIG. 2) can be mechanically joined together (e.g., mechanically connected, attached, fastened, etc.) to form the cup body 22. For example, one or more portions of the cup body 22 (e.g., one or more of the portions 40, 42, 44 of FIG. 2) can be mechanically joined (mechanically connected, mechanically attached, mechanically fastened, etc.) using mechanical fasteners (mechanical connectors, mechanical joints, etc.), that are separate from (not integrated with) the one or more portions to form the cup body 22. Exemplary mechanical fasteners (mechanical connectors, etc.) that are separate from the portions can include but are not limited to screws, rivets, pins, anchors, and the like.

As another example, one or more portions of the cup body 22 (e.g., one or more of the portions 40, 42, 44 of FIG. 2) can be mechanically joined (e.g., mechanically connected, mechanically attached, mechanically fastened, etc.) using integrated interlocking fasteners (e.g., integrated interlocking connectors, etc.), formed as integral parts of one or more of the portions of the cup body 22 during molding. In some embodiments, the intermediate portion can have an upper end and a lower end opposite one another, with the upper end in a facing relationship with the closed end-portion and the lower end in a facing relationship with the open end-portion. The upper end of the intermediate portion and the closed end-portion each can include integrated connectors that interlock with one another to attach the intermediate portion and the closed end-portion. In addition, or in the alternative, the lower end of the intermediate portion and the open end-portion each can include integrated connectors that interlock with one another to attach the intermediate portion and the open end-portion.

Integrated mechanical fastening systems can include without limitation snap-fit connectors, tongue-and-groove connectors, and the like. For example, one or more portions of the cup body 22 (e.g., one or more of the portions 40, 42, 44 of FIG. 2) can be mechanically joined using a snap-fit connection, in which one or more portions of the cup body 22 include an integrated molded protrusion configured (shaped) to insert into a corresponding integrated molded “snap-in” area (e.g., recess, cut-out, slot, etc.) of one or more of other portions to form a mechanical joint system when the protrusion is inserted into/interlocked with the snap-in area. As another example, one or more portions of the cup body 22 (e.g., one or more of the portions 40, 42, 44 of FIG. 2) can be mechanically joined using a tongue-and-groove connection, in which one or more portions of the cup body 22 can include an integrated molded slot (groove) along an edge configured (shaped) to tightly and fixedly receive a corresponding integrated molded ridge (tongue) along an edge of one or more other portions to form a mechanical joint system when the tongue is tightly and fixedly inserted into the groove.

In some embodiments, one or more portions of the cup body 22 (e.g., one or more of the portions 40, 42, 44 of FIG. 2) can be adhesively joined (e.g., adhesively connected, attached, fastened, etc.) using adhesives known in the art for adhering elastomeric (e.g., silicone) materials. In some embodiments, the intermediate portion 40 can have an upper end and a lower end opposite one another, with the upper end in a facing relationship with the closed end-portion 44 and the lower end in a facing relationship with the open end-portion 42. The cup body 22 can include an adhesive layer disposed on the upper end of the intermediate portion such that the adhesive layer is positioned between the intermediate layer and the closed end-portion and adheres the intermediate layer and the closed end-portion. In addition, or in the alternative, the cup body can include an adhesive layer on the lower end of the intermediate portion such that the adhesive layer is positioned between the intermediate layer and the open end-portion and adheres the intermediate layer and the open end-portion.

Examples of adhesives include without limitation silicone-based adhesives, such as silicone-epoxy-based adhesives, and/or cyanoacrylate-based adhesives. Reference is made, for example, to US 2019/0275771 to Meyers, published Sep. 12, 2019, now U.S. U.S. Pat. No. 10,577,521 issued Mar. 3, 2020, the entire disclosure of each of which is incorporated herein by reference.

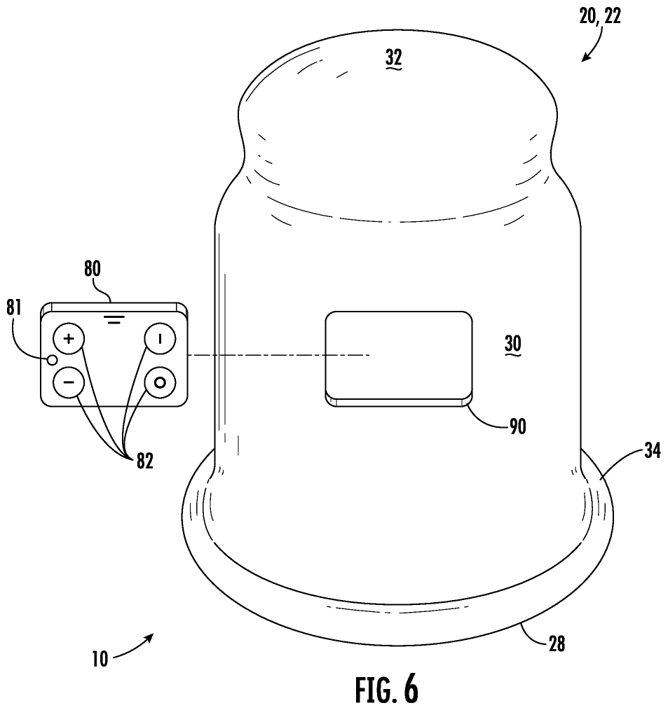

Other variations are also within the scope of this disclosure. For example, FIG. 6 depicts a system 10 in accordance with a second embodiment of this disclosure. The first and second embodiments can be alike, except for variations noted and variations that will be apparent to those of ordinary skill in the art.

In the second embodiment, the at least one sidewall 30 defines a cavity or receptacle 90 for removably receiving the vibration apparatus' housing 80 by way of an interference fit and/or in any other suitable manner, typically so that the housing can be securely (e.g., fixedly yet removably) mounted to the cup body 22. Alternatively, the vibration apparatus' housing 80 may be mounted to, or operatively associated with, the cup body 22 in any other suitable manner. Differently configured and positioned vibration apparatus 12, mounting receptacles 90, and/or other features of the system 10 are within the scope of this disclosure. Optionally it may be preferred for the vibration apparatus/housing 80 to be “built into” the body 22 by utilizing a receptacle 90, by way of over molding, and/or in any other suitable manner. For example, the vibration housing 80 can be embedded in the body 22, or more specifically embedded in the at least one sidewall 30, or associated with the cup body 22 in any other suitable manner. As a specific example, FIG. 4 schematically depicts the housing 80 embedded in (e.g., fully or substantially encased in, fully or substantially buried in, and/or fully or substantially enclosed in) the body 22, or more specifically embedded in the at least one sidewall 30 of the body. It is believed that the housing 80 can be at least partially embedded in the cup body 22 by way of over molding, insert molding, under molding, and/or in any other suitable manner.

Other variations are also within the scope of this disclosure. For example, FIG. 7 is an isolated cross-sectional view similar to FIG. 4 and depicting a container-shaped body 22 in accordance with a version of the first embodiment and/or in accordance with a third embodiment of this disclosure. The first, second, and third embodiments can be alike, except for variations noted and variations that will be apparent to those of ordinary skill in the art.

As an example, the cup body 22 depicted in FIG. 7 can be manufactured using over molding techniques, so that the cup body includes an initially-molded part 92 (e.g., an underlayer that is molded) and an over-molded part 94 (e.g., an overlayer that is molded). As another example, the initially-molded part 92 alone can be referred to as a body, and the over-molded part 94 can be referred to as a stiffening structure mounted to and at least partially embedded in the body of the initially-molded part 92.

In the example depicted in FIG. 7, the initially-molded part 92 can define a recess (e.g., an annular recess or groove) that is filled by the over-molded part 94, so that the over-molded part (e.g., annular over-molded part) extends completely around both the initially-molded part and the cup interior space 24. Alternatively, the one or more over-molded parts 94 can extend partially around the initially-molded part 92.

For forming the initially-molded part 92, a first molding material (e.g., a first silicone molding material) can be directed by way of a port into a first mold cavity corresponding in shape to the at-rest shape of the initially-molded part 92 and then be cross-linked (cured). Then, in a second or modified mold cavity at least partially containing the initially-molded part 92, a second molding material (e.g., a second silicone molding material) can be directed by way of a port into a respective portion of the mold cavity to cover at least a portion (e.g., cover the intermediate portion 40) of the initially-molded part 92 and then be cross-linked (cured) to form the over-molded part 94 extending at least partially (e.g., extending fully or completely) around the initially-molded part.

The first and second molding materials (e.g., silicones and/or other suitable materials) can have different properties such as different hardness and/or stiffness (e.g., different modulus of elasticity). For example, the intermediate portion 40, which includes the over-molded part 94, can be harder and/or stiffer than the portions 42, 44 that do not include the over-molded part. The increased hardness and/or stiffness of the intermediate portion 40 can be attributed, for example, to the use of a second molding material that is harder and/or stiffer (e.g., has a higher modulus of elasticity) than the first molding material and/or to an increased thickness of the intermediate portion 40 caused by the addition of the over-molded part 94.

In the example depicted in FIG. 7, the over-molded part 94 may be referred to as a fortifying (e.g., reinforcing and/or stiffening) element or feature. As another example, the initially-molded part 92 may be referred to as a body, and the over-molded part 94 may be referred to as structure (e.g., a fortification) that is mounted to the body and extends at least partially around the cup interior space 24. More specifically, the over-molded part 94 may be referred to as an outer band. As another example with respect to FIG. 7, it is believed that any sequence in which the parts 92, 94 are molded can be varied (e.g., the molded part 94 may be referred to as the initially-molded part and the molded part 92 may be referred to as an under-molded part). More generally and reiterating from above, it is believed that the cup body 22 can be at least partially formed by way of over molding, insert molding, under molding, and/or in any other suitable manner.

Other variations are also within the scope of this disclosure. For example, FIG. 8 is an isolated cross-sectional view similar to FIG. 4 and depicting a container-shaped body 22 in accordance with a version of the first embodiment and/or in accordance with a fourth embodiment of this disclosure. The first, second, and fourth embodiments can be alike, except for variations noted and variations that will be apparent to those of ordinary skill in the art.

As an example, the cup body 22 depicted in FIG. 8 can be manufactured using over molding techniques, so that the cup body includes an initially-molded part 92 (e.g., an underlayer that is molded) and an over-molded part 94 (e.g., an overlayer that is molded). As another example, the over-molded part 94 alone can be referred to as a body, and the initially-molded part 92 can be referred to as a stiffening structure mounted to and at least partially embedded in the body of the over-molded part 94. In the example depicted in FIG. 8, the initially-molded part 92 can an annular tube, and the over-molded part 94 can extend completely around the initially-molded part.

For forming the initially-molded part 92, a first molding material (e.g., a first silicone molding material) can be directed by way of a port into a first mold cavity corresponding in shape to the at-rest shape of the initially-molded part 92 and then be cross-linked (cured). Then, in a second or modified mold cavity at least partially containing the initially-molded part 92, a second molding material (e.g., a second silicone molding material) can be directed by way of a port into a respective portion of the mold cavity to cover at least a portion of the initially-molded part 92 and then be cross-linked (cured) to form the over-molded part 94 extending at least partially (e.g., extending fully or completely) around the initially-molded part.

In the example depicted in FIG. 8, the over-molded part 94 can define a recess (e.g., an annular recess or groove) that is filled by the initially-molded part 92, so that the initially-molded part extends completely around the cup interior space 24. Also in the example depicted in FIG. 8, the initially-molded part 92 may be referred to as a fortifying (e.g., reinforcing and/or stiffening) element or feature. As another example, the over-molded part 94 may be referred to as a body, and the initially-molded part 92 may be referred to as structure (e.g., a fortification) that is mounted to the body and extends at least partially around the cup interior space 24. More specifically, the initially-molded part 92 may be referred to as an inner band.

The first and second molding materials (e.g., silicones and/or other suitable materials) can have different properties such as different hardness and/or stiffness (e.g., different modulus of elasticity). For example, the intermediate portion 40, which includes the initially-molded part 92, can be harder and/or stiffer than the portions 42, 44 that do not include the initially-molded part. The relatively high hardness and/or stiffness of the intermediate portion 40 can be attributed, for example, to the use of a first molding material that is harder and/or stiffer (e.g., has a higher modulus of elasticity) than the second molding material and/or to an increased thickness of the intermediate portion 40 caused by its inclusion of the initially-molded part 92. As another example with respect to FIG. 8, it is believed that any sequence in which the parts 92, 94 are molded can be varied (e.g., it is believed that the molded part 94 may be referred to as the initially-molded part and the molded part 92 may be referred to as an under-molded part). More generally and reiterating from above, it is believed that the cup body 22 can be at least partially formed by way of over molding, insert molding, under molding, and/or in any other suitable manner.

As another example of variations, differently configured cup bodies 22 are within the scope of this disclosure. For example, whereas some features have been described above as being annular or cylindrical, the sidewall 30 can alternatively be replaced by, or be in the form of, one or more sidewalls configured so that the cup body 22 is shaped differently, such as by being oblong, rectangular, elliptical, more spherical, and/or in any other suitable shape. As another example, the vibration apparatus 12 may be used with a relatively rigid (e.g., glass) cup body having an interior space that is partially evacuated using a vacuum pump.

As further examples, the relatively less flexible or relatively rigid zone(s) (e.g., portion(s)) of the cup body 22 can be provided in a variety of ways. For example, the relatively high rigidity can be provided by embedding (e.g., inserting) one or more articles at predetermined locations in the at least one sidewall 30. The embedded feature(s) may or may not extend around (e.g., encircle) the cup interior space 24. For example, if there is enough of the relatively rigid material embedded in (e.g., buried in) or otherwise associated with the respectively portion of the wall 30 (e.g., silicone wall) the relatively rigid material can make the wall stiff enough without the relatively rigid material completely encircling the cup interior space 24. The embedded features can be pieces of polymeric material (e.g., plastic) and/or other suitable materials. For example, the embedded or other suitable stiffening features can be constructed of any suitable material and be arranged in any suitable patterns. It is believed that the embedded or other suitable stiffening features can be vertical ribs of bamboo, plastic, wood, metal, etc. In the embodiment depicted, for example, in FIGS. 2 and 4, the embedded or other suitable stiffening features can be in or otherwise associated with the intermediate portion 40 between the opposite open and closed end-portions 42, 44, for providing, for example, at least some of the advantageous operational characteristics discussed above.

As further examples and regarding the above-referenced computerized controller that can be contained, for example, by the housing 80 of the vibration apparatus 12, in addition to or alternatively to controlling and/or monitoring the system 10 by way of the user interface and computer features of the housing 80, the system 10 can be at least partially controlled and/or monitored by way of other suitable features. For example, one or more of the suction cups can be controlled and/or monitored remotely by way of wired or wireless (e.g., short-range wireless) communications with other computerized devices (e.g., smartphones; smartwatches; personal digital assistants; portable, tablet, or mobile computers; desktop computers; and/or any other suitable computerized devices). Each suction cup can include sensors and/or other suitable features for sensing, collecting, and relaying information such as battery life, suction pressure, selected program, time left in program or how long the program has been executing, timer/stopwatch functions, and/or any other suitable information. Optionally, a suction cup that can be controlled wirelessly may typically also include local controls in case the wireless controls become inoperable.

Further regarding the above-reference program, by way of executing a software or firmware program, or the like, on one or more of the respective computerized devices, the suction cups can be set to a program which allows them to be controlled together or separately or in preset patterns. The suction cups may be identified by a color or number printed on them, or the like. The suction cups may be of one or multiple sizes and durometers. The size and/or durometer characteristics can be distinguished by colors, numbers, and/or the like. For each suction cup, at least some or a majority of it may be clear so that the consumer or professional using the cup can see the skin to which the cup is applied and the color of the skin.

In addition to or alternatively to automatically controlling vibration by way of any one or more of the above-discussed computerized devices, the partial vacuum within the cup interior space 24 and the resulting suctional force applied to the skin of a user can be automatically controlled and/or monitored by way of any one or more of the above-discussed computerized devices. For example, the suctional force can be automatically adjusted by adjusting the tightness of the strap or band 84 (if present) with a suitable apparatus (e.g., an electromechanical actuator). As another example, the suctional force can be automatically adjusted by any other suitable apparatus (e.g., an electromechanical actuator, vacuum pump, and/or the like) mounted to the cup body 22 (e.g., mounted to the body's closed end-portion 44) and/or in fluid communication with the body's interior space 24.

When the suction cups (e.g., the housing 80) include battery(s), the battery(s) can be recharged with an electrical cord and/or wirelessly. For example, recharging can be accomplished using a charging base that may optionally include its own battery(s), an indicator light configured to indicate when battery(s) are fully charged, and/or any other suitable features.

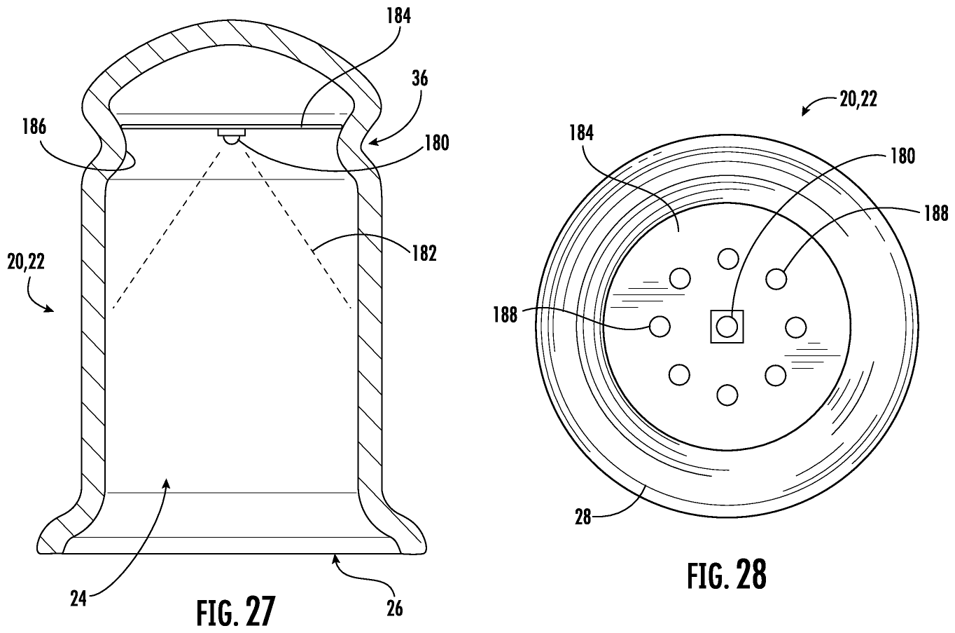

FIG. 4 schematically depicts an example of the vibration housing 80, or the like, mounted to the cup body 22, or more specifically embedded in the at least one wall 30 of the body, although the housing can be mounted in any suitable manner, other examples of which are described above and below. FIG. 4 further schematically depicts several devices within or otherwise associated with the housing 80, wherein the devices (e.g., at least some electronic components) are schematically designated by numeral 100. The devices 100 can respectively be, for example, at least one battery, at least one electric motor powered by the battery(s), a rotary output shaft of the motor to which an eccentric mass is connected, at least one emitter (see, e.g., LED 180 in FIGS. 27-30) configured to emit electromagnetic radiation (e.g., light, red light, and/or infrared radiation) powered by the battery(s), one or more sensors, electromagnetic signal transmitter(s) and/or receiver(s), and at least one controller.

The at least one controller (see, e.g., 100 of FIG. 4) of the vibration apparatus 12, or the at least one controller associated with the housing 80, can include one or more computers, computer data storage devices, programmable logic devices (PLDs) and/or application-specific integrated circuits (ASIC). A suitable computer can include one or more of each of a central processing unit or processor, computer hardware integrated circuits or memory, user interface, peripheral or equipment interface for interfacing with other electrical components of the system, and/or any other suitable features. The controller(s) can respectively communicate with electrical components of the system by way of suitable signal communication paths (e.g., wired and/or wireless).

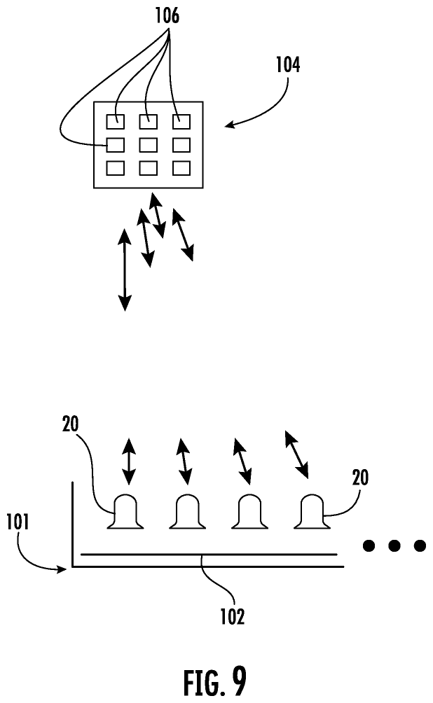

In the example schematically depicted in FIG. 9, one or more of the above-described and/or below-described suction cups 20 with any number of the associated features as described above and/or below can be arranged in or otherwise associated with a tray or other suitable container 101 and/or the like (e.g., a charging station). The container or other suitable station 101 can include or be associated with one or more charging ports or one or more conventional charging pads 102 for charging batteries associated with the suction cups 20.

With continued reference to FIG. 9 and at least partially reiterating from above, each suction cup 20 can be operatively associated with at least one “remote” computerized device 104 by way of electrical wires and/wirelessly. Optionally the computerized device 104 can be spaced apart from the suction cups 20. Reiterating from above, the “optionally remote” one or more computerized devices 104 can be, for example, smartphones; smartwatches; personal digital assistants; portable, tablet, or mobile computers; desktop computers; and/or any other suitable computerized devices. The computerized device 104 depicted in FIG. 9 can include or be associated with devices (e.g., at least some electronic components) that are schematically designated by numeral 106. The devices 106 can respectively be, for example, at least one battery, electromagnetic signal transmitter(s) and/or receiver(s), and at least one controller, one or more conventional user interfaces, and/or the like. The at least one controller (see, e.g., 106 of FIG. 9) can include one or more computers, computer data storage devices, programmable logic devices (PLDs) and/or application-specific integrated circuits (ASIC). A suitable computer can include one or more of each of a central processing unit or processor, computer hardware integrated circuits or memory, user interface, peripheral or equipment interface for interfacing with other electrical components of the system, and/or any other suitable features. The controller(s) can respectively communicate with electrical components of the system by way of suitable signal communication paths (e.g., wired and/or wireless).

The one or more suction cups 20 can be monitored, controlled, programmed, reprogrammed, and/or otherwise interacted with by way of their own computerized devices 80 and/or by way of one of more of the “remote” computerized devices 104 that is very close to or numerous feet away from the cups. Wireless electromagnetic communications between the suction cups 20 and the “remote” computerized device 104 are schematically represented by double-ended arrows in FIG. 9, and they can include communications by way of any suitable wireless technology (e.g., via a short-range wireless technology such as Bluetooth® wireless technology).

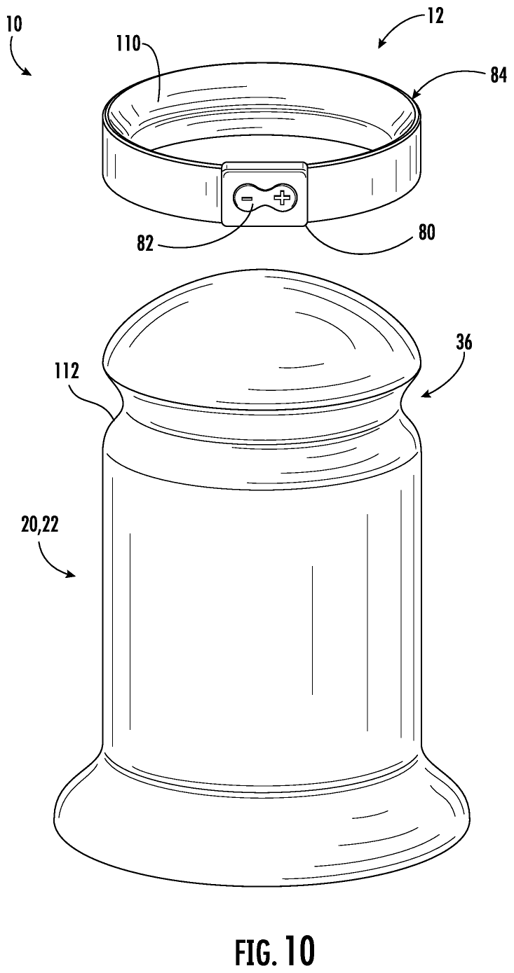

FIG. 10 is an exploded view of a therapeutic system 10 in accordance with a fifth embodiment of this disclosure. The first through fifth embodiments can be alike, except for variations noted and variations that will be apparent to those of ordinary skill in the art.

In the fifth embodiment, the mounting structure 84 that carries the vibration apparatus 12 (an accessory) can be in the form of a hoop, partial hoop, partial band, strap, and/or any other suitable structure. More specifically, FIG. 10 depicts the mounting structure 84 in the form of a band 84. The housing 80 of the vibration apparatus 12 can be securely (e.g., fixedly) mounted to and/or at least partially incorporated into the band 84. For example, the band 84 can have an outer surface to which the vibration apparatus housing 80 is fixedly mounted, or the vibration apparatus housing can be connected to the band 84 in any other suitable manner. Alternatively, the vibration apparatus 12 can be incorporated into, or at least partially incorporated into, the band 84 (e.g., strap or hoop), as discussed further below.

The band 84 and/or the suction cup 20 can be flexible (e.g., elastic) so that the band can be mounted on the suction cup by way of the band being snapped (e.g., snap-fit) into place against a portion of the outer surface of the suction cup. As a more specific example, a portion of the suction cup 20 can be configured for having the vibration apparatus 12/the band 84 mounted thereon and/or at least partially thereinto, for example at least partially by way of one or more snap-fit connections. In this regard, the band 84 can include an inner surface 110 that at least partially, substantially, or completely conforms in shape to the portion 112 of the outer surface of the cup body 22 that defines the groove 36. The inner diameter of the band inner surface 110 can be about the same as, or slightly greater than, the outer diameter of the surface portion 112 of the cup body 22 that defines the groove 36.

The band 84 can be formed of flexible (e.g., elastic) material and/or the groove 36 can be defined by flexible (e.g., elastic) material so that the vibration apparatus 12 can be mounted to the cup body 22 by causing the band can be mated (e.g., snap-fit) into the groove. The band 84 and/or the material defining the groove 36 can be made of silicone and/or other suitable materials.

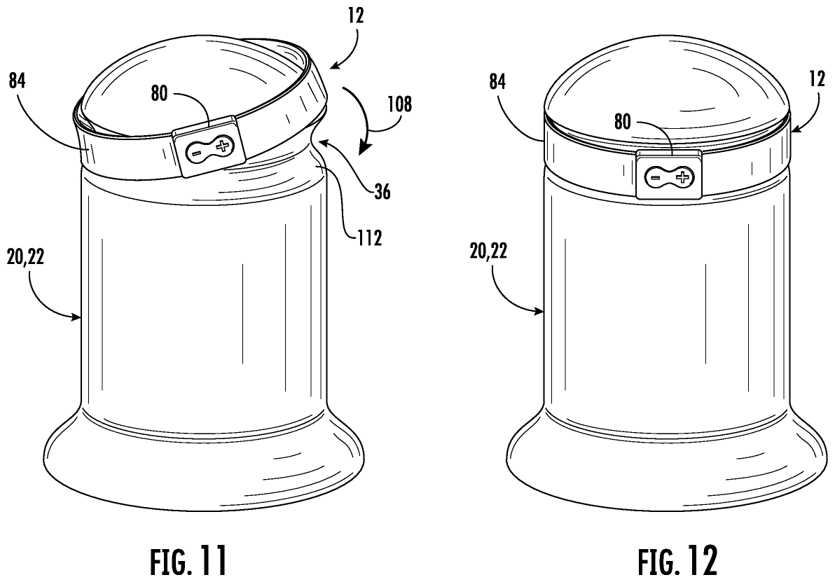

FIG. 11 schematically depicts (e.g., by way of an arrow designated by numeral 108) the band 84 being manually snap-fit onto the suction cup 20 and into the groove 36. FIG. 12 depicts the band 84 fully mated in the groove 36 so that the band inner surface 110 is in opposing face-to-face contact with the outer surface portion 112 (FIGS. 10-11) of the cup body 22 that defines the groove 36. For example and as best understood with reference to FIGS. 7 and 8, the band inner surface 110 can be in opposing face-to-face contact with the respective outer surface portion 112 of the initially-molded part 92 (FIG. 7) or the over-molded part 94 (FIG. 8). The band inner surface 110 can be mounted to and in opposing face-to-face contact with any other suitable outer surface of the suction cup 20. For example, it is believed that the vibration apparatus 12/strap 84 depicted in FIG. 1 can be replaced by the vibration apparatus 12/band 84 depicted in FIGS. 10-12 and other bands discussed further below. The outer surface portion 112 can be, or can be part of, an annular band, as discussed further below. Reiterating from above, it is believed that the cup body 22 can be at least partially formed by way of over molding, insert molding, under molding, and/or in any other suitable manner; and the molded part 94 may be referred to as the initially-molded part and the molded part 92 may be referred to as an under-molded part.

When the band 84 is suitably mounted to a suitable portion of the suction cup 20, the band can be fixedly (although releasably) secured on the suction cup by way of an interference fit. As a more specific example, when the band 84 is fully mated in the groove 36 the band can be fixedly (although releasably) secured in the groove by way of an interference fit. The interference fit can be tight enough so that the band 84 will remain mounted (e.g., in the groove 36) until manually removed, and vibrations from the vibration apparatus 12 are efficiently transferred to the cup body 22 or the body of a portion of the suction cup.

The band 84 can be relatively rigid and may be referred to as a fortifying (e.g., reinforcing and/or stiffening) element or feature. The cup body 22 or the body of a portion of the suction cup 20 can be formed of a first molding material, and the band 84 can be formed of a second molding material. The first and second molding materials (e.g., silicones and/or other suitable materials) can have different properties such as different hardness and/or stiffness (e.g., different modulus of elasticity). For example, the band 84 can be harder and/or stiffer than the cup body 22 or the body of a portion of the suction cup 20. The relatively high hardness and/or stiffness of the band 84 can be attributed, for example, to the second molding material being harder and/or stiffer (e.g., having a higher modulus of elasticity) than the second molding material and/or to the band 84 being relatively thick. Further regarding the option of the band 84 being relatively rigid as compared to the cup body 22 or a portion thereof, in some examples the band can be highly and/or extremely stiff, rigid, and/or inflexible, for example due to being constructed of material having a very high modulus of elasticity and/or being relatively thick. For example the band 84 can be made of, or at least partially made of, metallic material, hard polymeric material (e.g., highly cross-linked thermosetting polymeric material), and/or any other suitable materials.

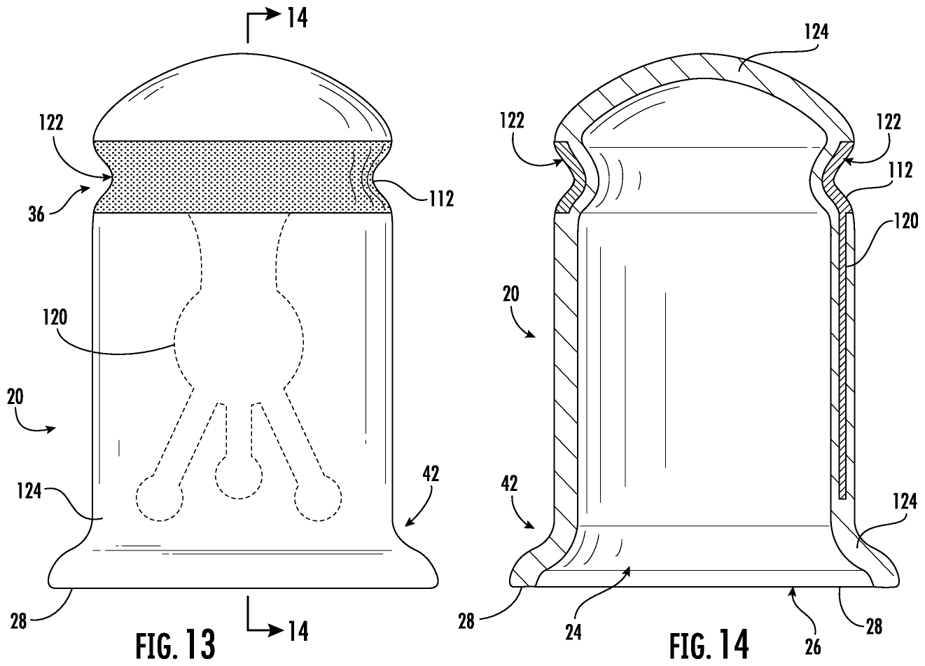

FIGS. 13-14 depict a suction cup 20 in accordance with a sixth embodiment of this disclosure. The first through sixth embodiments can be alike, except for variations noted and variations that will be apparent to those of ordinary skill in the art. In the sixth embodiment, at least one relatively stiff and/or relatively hard fortifying (e.g., reinforcing and/or stiffening) structure is mounted to the cup body 22 or the body of a portion of the suction cup 20. The fortifying structure can include at least one embedded part 120 (e.g., extension(s) and/or stiffener(s)) and at least one outer (e.g., exterior) part 122 (e.g., stiffener(s)). FIG. 13 is schematic because, for example, the one or more embedded parts 120 (e.g., extensions) are depicted with dashed lines, and the outer surface of the at least one outer part 122 is stippled for ease of understanding. One or the other of the embedded or outer parts 120, 122 can be omitted or configured differently than depicted in the drawings. In the cross-sectional view of FIG. 14, only one embedded part 120 is depicted. Alternatively, there can be two of the embedded parts 120 that are diametrically opposed from one another and/or any other suitable number, arrangement, and configuration of the embedded parts.

The outer part 122 can be referred to as a receiver and/or an affixed surface for having the vibration apparatus 12/band 84 (see, e.g., FIGS. 10-12) mounted thereon. For example, the vibration apparatus 12/band 84 can be mounted onto the outer surface portion 112 of the outer part 122 in the manner discussed above with reference to FIGS. 10-12. The at least one embedded part 120 can be in the form of one or more extensions that extend away from the outer part 122. The outer surface portion 112 of the outer part 122 can provide a relatively firm mounting surface to which the vibration apparatus 12 can be mounted. The at least one embedded part 120 can extend from the outer part 122 in a manner that seeks to help transmit (e.g., uniformly transmit) vibrations through the suction cup 20 or at least through a portion of the suction cup. The vibrations can propagate in and along each of the embedded parts 120.

The embedded and outer parts 120, 122 can be flexible yet harder and/or stiffer than other portions of the cup body 22 or the body of a portion of the suction cup 20 so that, for example, at least the embedded part 120 vibrates in a therapeutic manner in response to the vibrating of the vibration apparatus 12 mounted on the outer part 122. The one or more embedded parts 120, or portions thereof, can have a length extending along a length of the cup body 22 and be configured to transmit vibrations at least partially along the length of the cup body.

The one or more embedded parts 120 (e.g., stays, extending pieces of the outer part 122, or other suitable structures) can extend from the outer part 122 toward and/or into the cup's open end-portion 42 to transport the therapeutic vibrations originating from the vibration apparatus 12 to, proximate to, or at least near to the rim 28, so that the rim vibrates therapeutically. The outer part 122 can be an annular band.

In the example depicted in FIG. 13, the at least one embedded part 120 includes an upper section extending downwardly from the outer part 122, several lower sections extending downwardly and divergently from one another, and a somewhat circular medial section connected between the upper section and the lower sections of the embedded part. A variety of differently configured embedded parts are within the scope of this disclosure, as discussed further below.

The sixth embodiment cup body 22 depicted in FIGS. 13-14 can be formed by insert molding, so that cup body includes the embedded and outer parts 120, 122, and a later-molded part 124. The outer part 122 can be a relatively firm structure, and the one or more embedded parts 120 can be extending pieces that extend from the outer part and along at least a portion of the length of the suction cup 20 to transport/maintain vibration strength/efficacy. The embedded and/or outer parts 120, 122 can be referred to stiffeners that are at least partially embedded the cup body 22 or the body of a portion of the suction cup 20. The embedded and/or outer parts 120, 122 can be referred to as structure mounted to the body and extending at least partially around the cup interior space 24. More specifically, the outer part 122 can extend fully around the cup interior space 24 for having the vibration apparatus 12 of FIGS. 10-12 mounted thereon as discussed above.

In the example depicted in FIGS. 13-14, the later-molded part 124 can define recesses that are filled by the embedded and outer parts 120, 122, respectively. The embedded and outer parts 120, 122 can be formed of material that is harder and/or stiffer than (e.g., has a higher modulus of elasticity than) the later-molded part 124 (e.g., body), and each of these parts can be made of elastic silicone and/or other suitable materials.

Referring to FIGS. 10 and 13-14, the inner surface 110 of the band 84 and the outer surface portion 112 of the suction cup 20 can be referred to as mounting surfaces 110, 112 that are engaged or mated with one another. One or both of the mounting surfaces 110, 112 can be smooth. As another example, one or both of the mounting surfaces 110, 112 can define or otherwise include connector parts configured for at least partially facilitating the mounting of the vibration apparatus 12/band 84 onto the suction cup 20. For example, the one or more connector parts can include screw threads or the like and/or other suitable connector parts, as discussed further below.

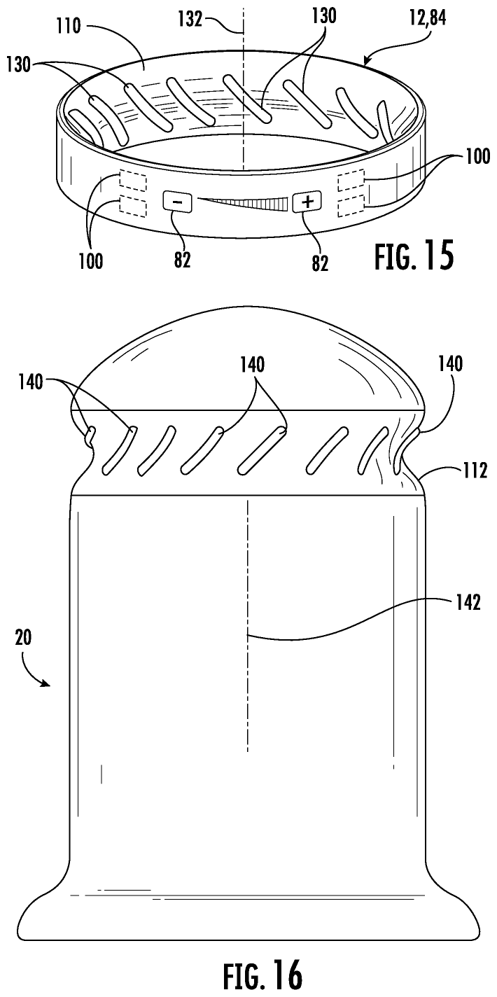

FIG. 15 depicts a vibration apparatus 12 in accordance with a seventh embodiment of this disclosure. The first through seventh embodiments can be alike, except for variations noted and variations that will be apparent to those of ordinary skill in the art.

In the example depicted in FIG. 15, components of the vibration apparatus 12 and the band 84 are relatively more integrally formed with one another than in earlier embodiments, wherein the vibration apparatus' electronic components 100 (FIG. 4) and buttons 82 are more fully (e.g., can be fully) incorporated into the band such that the band serves as a housing and the separate housing 80 (FIGS. 1, 6, 10-12) has been omitted. One or more of the above-discussed devices 100 (e.g., discussed above with reference to FIG. 4) can be mounted in the band 84 and hidden from view, and, thus, they are schematically represented by dashed lines in FIG. 15. Only a representative few of the devices 100 are schematically depicted in FIG. 15. Alternatively the housing 80 can be retained, hidden from view within the band 84, and/or the vibration apparatus can be in a variety of different configurations.

Also in the example depicted in FIG. 15, the band inner surface 110 defines a series of inwardly protruding ridges 130. Each of the inwardly protruding ridges 130 can protrude inwardly toward the central axis 132 of the band 84. The inwardly protruding ridges 130 can collectively extend around the band central axis 132. The inwardly protruding ridges 130 can extend obliquely to the band axis 132 and they, or variations thereof, may be described as being screw threads, helical screw threads, and/or other suitable connector parts. The inwardly protruding ridges 130 can function as, or similar to, screw threads to facilitate a screw-like mounting of the band 84 onto the suction cup 20 in response to relative rotation therebetween, for example by way of the inwardly protruding ridges engaging and inwardly deforming elastic material defining the outer surface of the suction cup.

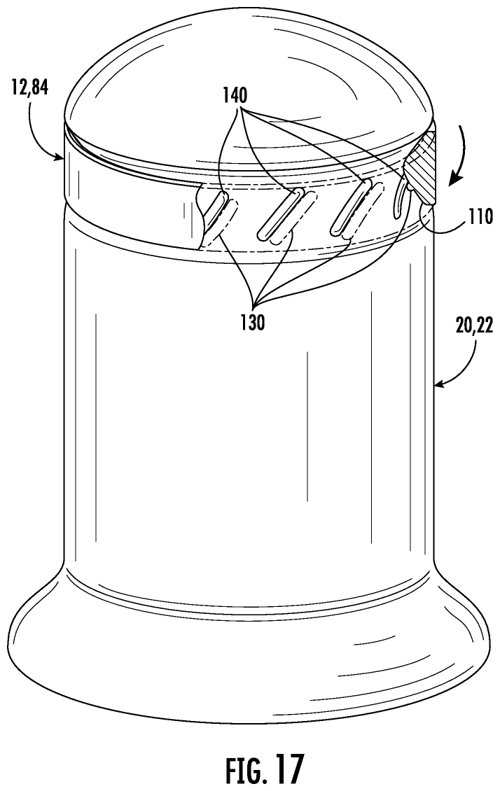

FIG. 16 depicts a suction cup 20 in accordance with the seventh embodiment, wherein the seventh embodiment suction cup can be like any of the suction cups described herein, except, for example, that the mounting surface 112 of the cup body 22 defines a series of outwardly protruding parts of ridges 140 that collectively extend around a central axis 142 of the suction cup 20. The outwardly protruding ridges 140 extend obliquely to the cup axis 142 and they, or variations thereof, may be described as being screw threads, helical screw threads, and/or other suitable connector parts. The outwardly protruding ridges 142 can function as, or similar to, screw threads to facilitate a screw-like mounting of the band 84 onto the suction cup 20 in response to relative rotation therebetween. For example and as best understood with reference to FIG. 17, the ridges 130, 140 (e.g., screw threads) can be respectively mated with one another in response to manual relative rotation in a first direction between the suction cup 20 and band 84, to releasably securely mount the band to the suction cup. The band 84 can be removed from the suction cup 20 in response to manual relative rotation in a second direction between the suction cup and band, wherein the first and second directions are rotational directions that are opposite from one another.

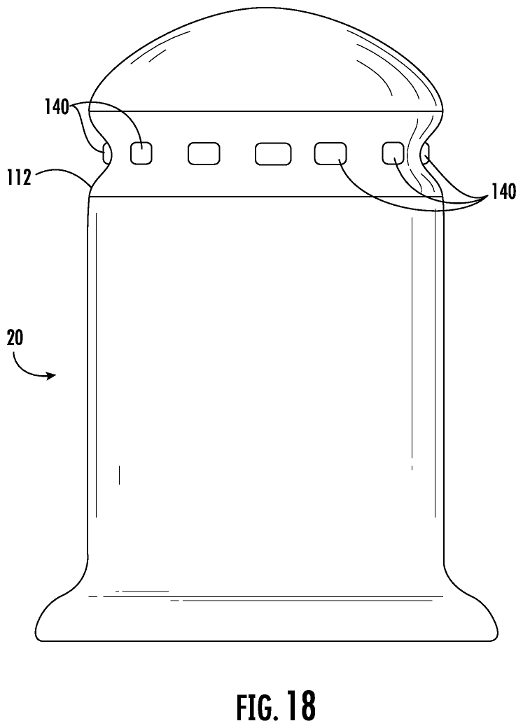

At least partially reiterating from above, the suction cup 10 and/or vibration apparatus 12 can include one or more connector parts configured for at least partially facilitating the mounting of the vibration apparatus 12 (e.g., band 84) to the suction cup 20, and the connector parts can be in a variety of different configurations. For example, in FIG. 18 the outwardly protruding parts 140 are rectangular with rounded corners, and the band's inwardly protruding ridges 130 (FIGS. 15 and 17) can respectively engage the lower right corners of the outwardly protruding parts 140 when the band 84 is fixedly, yet removably, mounted to the suction cup 20 in a manner similar to that depicted in FIG. 17.

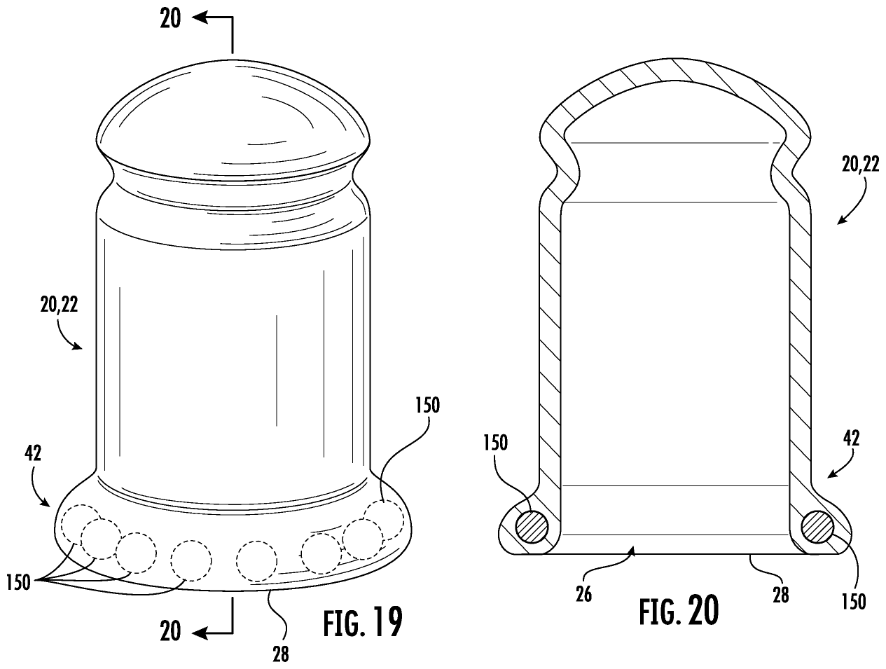

Referring back to FIGS. 13-14, the one or more embedded or outer parts 120, 122 are examples of a variety of differently configured and located types of reinforcements, stiffeners, stiffening materials, stays, inserts, or the like that can be at least partially embedded in the body 22 of the suction cup 20, or at least partially embedded in the body of a portion of the suction cup. FIGS. 19-20 depict other examples articles that can be at least partially embedded in the body 22 of the suction cup 20, or at least partially embedded in the body of a portion of the suction cup, in accordance with an eight embodiment of this disclosure. The first through eighth embodiments can be alike except for variations noted and variations that will be apparent to those of ordinary skill in the art.

In the example depicted in FIGS. 19-20 the embedded (or more generally the at least partially embedded) stiffeners 150 are depicted in the form of balls that are located in the relatively soft lower, open end-portion 42 of the suction cup 20, wherein the stiffeners or balls can be round, oval, spherical, ovoidal, and/or in any other suitable shape. FIG. 19 is schematic because, for example, the stiffeners 150 are depicted with dashed lines, as if they are hidden from view, although they may be visible when the main body of the open end-portion 42 is transparent. The stiffeners 150 or other suitable embedded material can be configured (e.g., can be relatively stiff) in a manner that seeks to restrict the open end-portion 42 and/or rim 28 from undesirably folding over onto itself during use of the suction cup 20. As another example, the stiffeners 150 can be configured in a manner that seeks to enhance the therapeutic massaging provided by the suction cup 20. The relatively stiff material (e.g., the one or more stiffeners 150) can be embedded in the relatively soft rim 28 and/or open end-portion 42 to both help at least partially maintain the shape of the rim and add or enhance massage benefits.

It is believed that the one or more stiffeners 150 can be in the form of a ring, gasket, annular gasket, spring, annular spring, consecutive balls, magnets, cording, and/or any other suitable structure (e.g., stiffening structure). The stiffeners 150 can be formed of flexible material (e.g., elastic silicone) or other suitable material. The stiffeners 150 may be referred to as rim inserts, stays, or the like. The one or more rim inserts, stays, or stiffeners 150 can be formed of material that is harder and/or stiffer than (e.g., has a higher modulus of elasticity than) a remainder of, or at least a substantial portion of, the open end-portion 42 of the cup body 22, and each of these parts can be made of elastic silicone and/or other suitable materials.

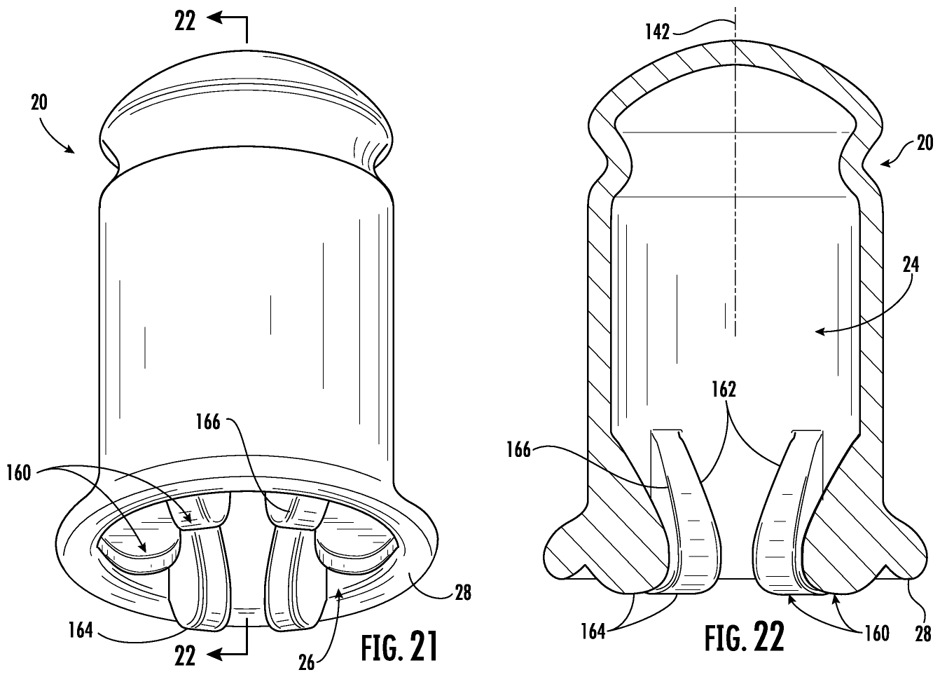

The open end-portion 42 of the cup body 22, the rim 28, the cup opening 26, and/or associated structure can include texture (e.g., shapes, protrusions, and/or recesses) configured to engage the user's skin to enhance the therapeutic massaging. For example, it is believed that the interior of the suction cup 20 can have shapes molded into the rim 28 and/or open end-portion 42 that engage the user's skin in a manner that provides deeper penetration and massage of skin that is sucked inwardly during massaging with the suction cup 20. As a more specific example, FIGS. 21-26 depict suction cups 20 that include one or more protrusions that are in the form of flexible (e.g., elastic) ridges 160, in accordance with a ninth embodiment of this disclosure. The first through ninth embodiments can be alike except for variations noted and variations that will be apparent to those of ordinary skill in the art.

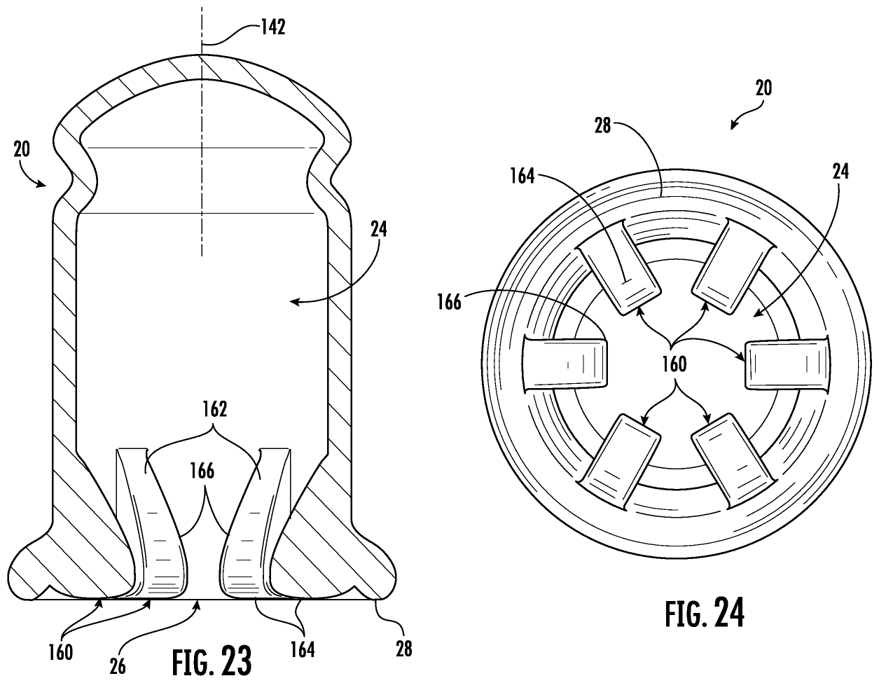

The ridges 160 can collectively extend at least partially around a portion of the cup interior space 24, and at least some of the ridges can extend inwardly into the cup interior space. In the version depicted in FIGS. 21-22, the lower end portions of the ridges 160 protrude outwardly through the cup opening 26. In the version depicted in FIGS. 23-24, the lower ends of the ridges 160 are flush with the cup opening 26 and rim 28.

The ridges 160 can be defined by (e.g., be molded with), or mounted to, the portion of the sidewall 30 that forms the cup's open end-portion 42. As examples, when the ridges 160 are defined by the portion of the sidewall 30 that forms the cup's open end-portion 42 and the open end-portion 42 is relatively soft as described above, the ridges 160 can also be relatively soft.

One or more of, or each of, the ridges 160 can have a length extending along the axis 142 of the suction cup 20. One or more of, or each of, the ridges 160 can have opposite ends in the form of a tapered upper end 162 and a lobed lower end 164. In the examples depicted in FIGS. 21-26, corners 166 are defined between respective faces of the ridges 160. The corners 166 can be smoother than depicted by being truncated, chamfered, and/or rounded, or the extent of the rounding can be such that the corners 166 are not present or substantially not present.

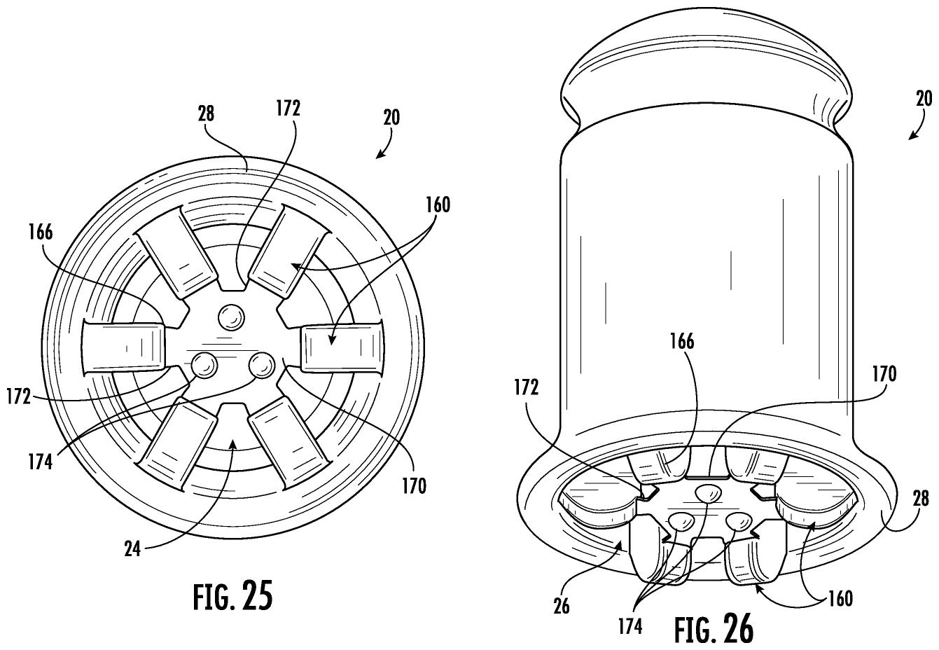

As best understood with reference to FIGS. 21-26, the ridges 160 can extend partially across and partially obstruct the cup interior space 24 and/or cup opening 26. Different features for extending at least partially across and at least partially obstructing the cup interior space 24 and/or cup opening 26 are within the scope of this disclosure. For example, FIGS. 25-26 depict one or more additional obstructing structures that extend at least partially across and at least partially obstruct the cup interior space 24 and/or cup opening 26. The additional obstructing structures depicted in FIGS. 25-26 include a flexible (e.g., elastic) partition 170 having connecting points or arms 172 respectively connected to the ridges 160, and flexible (e.g., elastic) protrusions 174 (e.g., dome-shaped or other suitable configured protrusions) extending downwardly from the partition. Alternatively the partition 170 can be supplemented by and/or replaced by one or more other suitable structures, for example, linear elements that can include rigid structures (e.g., rods and/or dowels) and flexible (e.g., cord like) structures (e.g., ropes, cables, strings, wires, and/or other flexible tensile members). Such linear structure(s), or other suitable structure(s), can respectively connected the ridges 168 to one another, extend at least partially across the cup interior space 24 and/or cup opening 26, and partially obstruct the cup interior space 24 and/or cup opening 26.

The partition 170 can be in the form of a web or panel, and the protrusions 174 can be integral parts of the partition or mounted to the partition. The partition 170 and protrusions 174 can be formed of elastic silicone and/or other suitable materials. It is believed that the partition 170 can be joined to the ridges 160 or other suitable portions of the suction cup in any suitable manner with connector(s), adhesive(s) (e.g., silicone adhesive), and/or by way of suitable techniques. The partition 170 can provide reinforcement and/or support (e.g., structural support) to the ridges 160 and, thus, may enhance therapeutic effects. At least partially reiterating from above, the partition 170 can further include one or more features configured to make contact with the skin being exposed to suction by the suction cup 20, wherein these features can be configured to at least partially provide enhanced therapeutic massage, and these features can be in the form of the protrusions 174 and/or any other suitable structure(s). As an example, one or more of, or each of, the ridges 162, partition 170, and protrusions 174 can be formed of the same material as (e.g., have the same modulus of elasticity as) the cup open end-portion 42, which can be in contrast to other portions of the suction cup 20, as discussed above.

During use of the suction cup 20, the lower ends of the ridges 160 and/or protrusions 174 can engage, and may at least partially depress, the user's skin to enhance the therapeutic massaging. As another example of use of the suction cup 20, the lower ends of the ridges 160 can be configured so that as the user's skin that is sucked into the cup interior space 24, that or associated skin may be affected in a non-uniform way that may lead to deeper massage of the tissue (e.g., user's skin) and increased blood flow. Areas between adjacent ridges 160 can be referred to as recesses (e.g., gaps), and it is believed that tissue (e.g., user's skin) can be drawn at least partially into the recesses.

Other embodiments are within the scope of this disclosure. For example, a tenth embodiment of the suction cup 20 can include at least one emitter configured to emit electromagnetic radiation (e.g., light, red light, and/or infrared radiation) in a manner that seeks to provide a therapeutic effect. The first through tenth embodiments can be alike except for variations noted and variations that will be apparent to those of ordinary skill in the art.

FIGS. 27-30 depict examples of suction cups 20 in accordance with a tenth embodiment, wherein at least one emitter in the form of a light-emitting diode (LED) 180 is mounted to the suction cup 20 and configured to emit light, red light, and/or infrared radiation that will impinge upon at least the user's skin that is sucked into the cup interior space 24. For example, the at least one LED 180 can emit the electromagnetic radiation (e.g., light, red light, and/or infrared radiation) at a beam angle 182, and the cup opening 26 can be positioned in the beam angle 182 (e.g., in the conical beam angle 182). The LED 180 can be mounted and/or suspended in the cup interior space 24, for example by being mounted directly to an interior surface of the cup body 22 (e.g., the silicone cup body), by being mounted to a support (e.g., web, panel, and/or platform) embedded in the cup body, and/or by being mounted to a support (e.g., web, panel, and/or platform) connected to cup body.

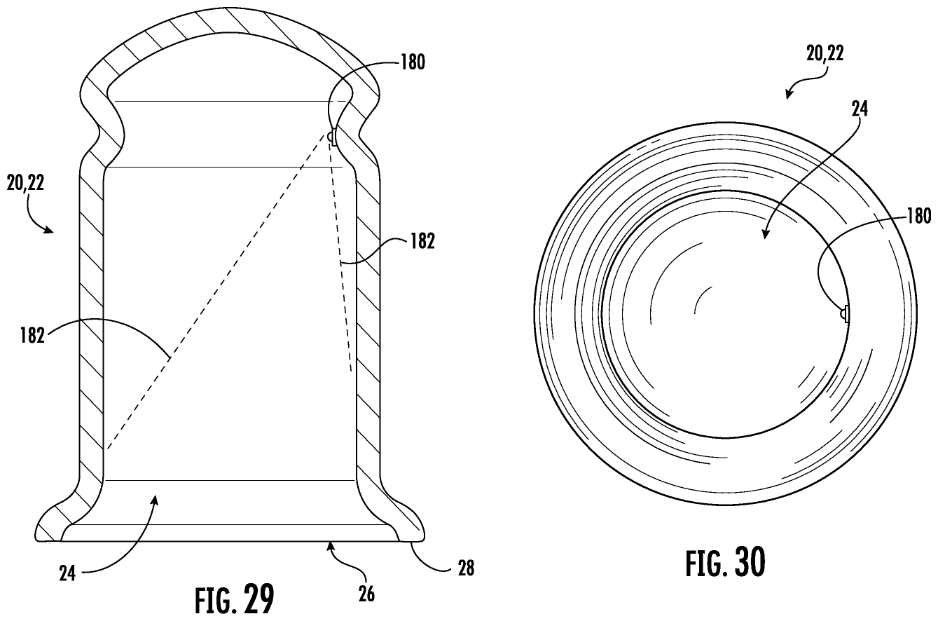

In the version depicted in FIGS. 27-28, the LED 180 is suspended centrally in the cup interior space 24 by suspending structure that can be in the form of self-supporting flexible (e.g., elastic) or relatively rigid circular disk, panel, or platform 184. The platform 184 can have an annular periphery engaged against and supported by an upper surface of an internal annular shoulder 186 of the cup body 22. The platform 184 can divide the cup interior space 24 into chambers. One or more holes 188 extending through the platform 184 can cause the chambers that are partially separated by the platform 184 to be in fluid communication with one another. Alternatively the LED 180 can be suspended by any other suitable structures, for example, linear elements that can include rigid structures (e.g., rods and/or dowels) and flexible (e.g., cord like) structures (e.g., ropes, cables, strings, wires, and/or other flexible tensile members). In the version depicted in FIGS. 29-30, the LED 180 can be directly or indirectly mounted to an interior surface of the cup body 22 (e.g., the silicone cup body).

An example of an aspect of this disclosure is the provision of an improved cup for therapeutic cupping massage that includes both a vibration feature and an enhanced cup design that comprises relatively soft and relatively rigid structural elements.

Another example of an aspect of this disclosure is the provision of a silicone massage cup of any suitable size that can have a rim that is relatively soft and/or relatively less stiff as compared to at least some of or all of a reminder of the body of the cup, wherein the cup can incorporate a rechargeable vibration unit that can be controlled directly by way of manual input and/or can be controlled at least somewhat remotely, for example wirelessly via smartphone or unique computerized tablet, etc.

For example, providing therapeutic cupping massage to a user's body is a way to improve circulation by bringing localized blood flow to the treated area which can provide pain relief, reduce muscle tension and tightness, release scar tissue and fascial adhesions, reduce painful trigger points, and/or promote mobility.

In the above examples, the suction cups 20 are often discussed in the context of being configured for use in cupping therapy. However, it is believed that the suction cups 20 can be used for a variety of other purposes as would be understood by those of ordinary skill in the art (e.g., the scope of this disclosure is not limited to cupping therapy).

A variety of examples are within the scope of this disclosure, including the following examples.
Example 1. A suction cup configured to be used in cupping therapy, the suction cup comprising: a body, wherein at least a portion of the body is elastic and configured so that the body is capable of being squeezed to transition the body from an at-rest configuration to a partially-collapsed configuration, and the body is elastically biased toward the at-rest configuration, wherein volume of an interior space of the suction cup is greater in the at-rest configuration than in the partially-collapsed configuration, and wherein the body comprises: at least one sidewall extending at least partially around the interior space of the suction cup, and a rim extending at least partially around an opening to the interior space of the suction cup and configured to be engaged against a user during cupping therapy; and structure mounted to the body and extending at least partially around the interior space of the suction cup, wherein a first portion of the body together with the structure is stiffer than a second portion of the body.
Example 2. The suction cup according to Example 1, wherein the structure comprises: a band; a vibration apparatus in the band; and at least one ridge protruding inwardly from the band and configured to at least partially connect the band to the body.
Example 3. The suction cup according to Example 2, wherein the at least one ridge comprises a screw thread.
Example 4. The suction cup according to Example 1, wherein: the structure is more rigid than at least a portion of the body underlying the structure; and the structure is configured to have an accessory mounted thereon.
Example 5. The suction cup according to Example 4, wherein: the accessory comprises a vibration apparatus; and an extension extends from the structure and is configured to transmit vibration along a length of the body.
Example 6. The suction cup according to Example 4, wherein at least one protrusion extends outwardly from the structure and is configured to at least partially connect an accessory to the structure.
Example 7. The suction cup according to Example 6, wherein the at least one ridge comprises a screw thread.
Example 8. The suction cup according to Example 1, wherein the structure is an overlayer that extends at least partially around the body.
Example 9. The suction cup according to Example 1, wherein the structure is an underlayer and the body extends at least partially around the underlayer.
Example 10. The suction cup according to Example 1, wherein the rim is part of the second portion of the body.
Example 11. The suction cup according to Example 1, comprising an electromechanical vibrator mounted to the body by way of the structure.
Example 12. The suction cup according to Example 1, wherein the body defines a recess and the structure is mated in the recess.
Example 13. The suction cup according to Example 12, wherein the structure being mounted to the body is comprised of there being a snap-fit connection between the structure and the body.
Example 14. The suction cup according to Example 12, wherein: the recess is an annular groove; and the structure is annular.
Example 15. The suction cup according to Example 12, wherein the structure comprises a strap.
Example 16. The suction cup according to Example 12, wherein the structure comprises a band.
Example 17. The suction cup according to Example 1, wherein the structure comprises a connector part configured to engage with the body to at least partially mount the structure to the body.
Example 18. The suction cup according to Example 17, wherein the connector part comprises an inwardly protruding ridge.
Example 19. The suction cup according to Example 17, wherein the connector part comprises at least a portion of an inwardly protruding screw thread.
Example 20. The suction cup according to Example 17, wherein the body comprises an outwardly protruding connector part engaged with the inwardly protruding connector part of the structure.
Example 21. A suction cup configured to be used in cupping therapy, the suction cup comprising: a body, wherein at least a portion of the body is elastic and configured so that the body is capable of being squeezed to transition the body from an at-rest configuration to a partially-collapsed configuration, and the body is elastically biased toward the at-rest configuration, wherein volume of an interior space of the suction cup is greater in the at-rest configuration than in the partially-collapsed configuration, and wherein the body comprises: at least one sidewall extending at least partially around the interior space of the suction cup, and a rim extending at least partially around an opening to the interior space of the suction cup and configured to be engaged against a user during cupping therapy; and a stiffener at least partially embedded in the body.
Example 22. The suction cup according to Example 21, wherein: the stiffener is at least partially embedded in an open end-portion of the body; the open end-portion of the body includes the rim; and the stiffener is configured to enhance therapeutic massaging.
Example 23. The suction cup according to Example 21, wherein: the stiffener is one of a plurality of stiffeners that are at least partially embedded in an open end-portion of the body; the open end-portion of the body includes the rim; and the plurality of stiffeners collectively extend at least partially around the interior space of the suction cup.
Example 24. The suction cup according to Example 21, wherein the stiffener is a ball.
Example 25. The suction cup according to Example 21, wherein: the body comprises an intermediate portion between opposite end portions; the opposite end portions comprise an open end-portion and a closed end-portion; the open end-portion comprises the rim and defines the opening; and the stiffener is positioned in the open end-portion.
Example 26. The suction cup according to Example 21, wherein: the body comprises an intermediate portion between opposite end portions; the opposite end portions comprise an open end-portion and a closed end-portion; the open end-portion comprises the rim and defines the opening; and the stiffener is positioned in the intermediate portion.
Example 27. The suction cup according to Example 21, wherein: the body comprises an intermediate portion between opposite end portions; the opposite end portions comprise an open end-portion and a closed end-portion; the open end-portion comprises the rim and defines the opening; and the stiffener is positioned in the closed end-portion.
Example 28. The suction cup according to Example 21, wherein the stiffener extends at least partially around the interior space of the suction cup.
Example 29. The suction cup according to Example 21, wherein: the stiffener has a length extending along a length of the body; and the stiffener is configured to transmit vibration along at least a portion of the length of the body.
Example 30. The suction cup according to Example 29, comprising structure configured to have a vibration apparatus mounted thereon, wherein the stiffener extends from the structure configured to have a vibration apparatus mounted thereon.
Example 31. A suction cup configured to be used in cupping therapy, the suction cup comprising: a body, wherein at least a portion of the body is elastic and configured so that the body is capable of being squeezed to transition the body from an at-rest configuration to a partially-collapsed configuration, and the body is elastically biased toward the at-rest configuration, wherein volume of an interior space of the suction cup is greater in the at-rest configuration than in the partially-collapsed configuration, and wherein the body comprises: at least one sidewall extending at least partially around the interior space of the suction cup, a rim extending at least partially around an opening to the interior space of the suction cup and configured to be engaged against a user during cupping therapy, and a plurality of protrusions, wherein at least some protrusions of the plurality of protrusions extend inwardly into the interior space of the suction cup.
Example 32. The suction cup according to Example 31, wherein at least some protrusions of the plurality of protrusions extend outwardly through the opening to the interior space of the suction cup.
Example 33. The suction cup according to Example 31, wherein: at least some protrusions of the plurality of protrusions are ridges; and at least one ridge of the ridges has a length extending along an axis of the body.
Example 34. The suction cup according to Example 33, wherein: the at least one ridge comprises opposite first and second ends; the first end is positioned in the interior space of the suction cup; and the second end is proximate the rim.
Example 35. The suction cup according to Example 34, wherein the second end of the at least one ridge is a lobe that protrudes outwardly from the opening to the interior space of the suction cup.
Example 36. The suction cup according to Example 34, wherein the first end of the at least one ridge is tapered.
Example 37. A suction cup configured to be used in cupping therapy, the suction cup comprising: a body, wherein at least a portion of the body is elastic and configured so that the body is capable of being squeezed to transition the body from an at-rest configuration to a partially-collapsed configuration, and the body is elastically biased toward the at-rest configuration, wherein volume of an interior space of the suction cup is greater in the at-rest configuration than in the partially-collapsed configuration, and wherein the body comprises: at least one sidewall extending at least partially around the interior space of the suction cup, and a rim extending at least partially around an opening to the interior space of the suction cup and configured to be engaged against a user during cupping therapy; and an emitter mounted to the body and configured to emit electromagnetic radiation into the interior space of the suction cup so that at least some of the electromagnet radiation emitted into the interior space of the suction cup passes outwardly through the opening to the interior space of the suction cup.
Example 38. The suction cup according to Example 37, wherein the emitter comprises a light-emitting diode.
Example 39. The suction cup according to Example 37, wherein the electromagnetic radiation comprises red light and/or infrared radiation.
Example 40. The suction cup according to Example 37, wherein: the body includes an inner surface in opposing face-to-face contact with the interior space of the suction cup; and the emitter is mounted to the inner surface of the body.
Example 41. The suction cup according to Example 37, wherein the emitter is suspended in the interior space of the suction cup.

The entire disclosure of each of U.S. Provisional Patent Application No. 63/063,537, filed Aug. 10, 2020, and International Patent Application No. PCT/US2021/045207, filed Aug. 9, 2021, and published Feb. 17, 2022, as WO 2022/035753 A1, is incorporated herein by reference in its entirety.

Reiterating from above, it is within the scope of this disclosure for one or more of the terms “substantially,” “about,” “approximately,” and/or the like, to qualify each of the adjectives and adverbs of the foregoing disclosure, for the purpose of providing a broad disclosure. As an example, it is believed that those of ordinary skill in the art will readily understand that, in different implementations of the features of this disclosure, reasonably different engineering tolerances, precision, and/or accuracy may be applicable and suitable for obtaining the desired result. Accordingly, it is believed that those of ordinary skill will readily understand usage herein of the terms such as “substantially,” “about,” “approximately,” and the like. As another example, variations may occur as molds wear and/or are replaced, or the like. Those of ordinary skill in the art will understand that, in such a molding manufacturing process, typically there are engineering tolerances comprising permissible limits in variations of dimensions, and the tolerances can vary in different circumstances. Accordingly, it is believed that those of ordinary skill will readily understand usage herein of the terms such as “substantially,” “about,” “approximately,” and the like.

In the specification and drawings, examples of embodiments have been disclosed. The present invention is not limited to such exemplary embodiments. The use of the term “and/or” includes any and all combinations of one or more of the associated listed items. Unless otherwise noted, specific terms have been used in a generic and descriptive sense and not for purposes of limitation.

1. A suction cup configured to be used in cupping therapy, the suction cup comprising:
a body, wherein at least a portion of the body is elastic and configured so that the body is capable of being squeezed to transition the body from an at-rest configuration to a partially-collapsed configuration, and the body is elastically biased toward the at-rest configuration, wherein volume of an interior space of the suction cup is greater in the at-rest configuration than in the partially-collapsed configuration, and wherein the body comprises:
at least one sidewall extending at least partially around the interior space of the suction cup, and
a rim extending at least partially around an opening to the interior space of the suction cup and configured to be engaged against a user during cupping therapy; and
structure mounted to the body and extending at least partially around the interior space of the suction cup, wherein a first portion of the body together with the structure is stiffer than a second portion of the body.

2. The suction cup according to claim 1, wherein the structure comprises:
a band;
a vibration apparatus in the band; and
at least one ridge protruding inwardly from the band and configured to at least partially connect the band to the body.

3. The suction cup according to claim 2, wherein the at least one ridge comprises a screw thread.

4. The suction cup according to claim 1, wherein:
the structure is more rigid than at least a portion of the body underlying the structure; and
the structure is configured to have an accessory mounted thereon.

5. The suction cup according to claim 4, wherein:
the accessory comprises a vibration apparatus; and
an extension extends from the structure and is configured to transmit vibration along a length of the body.

6. The suction cup according to claim 4, wherein at least one protrusion extends outwardly from the structure and is configured to at least partially connect an accessory to the structure.

7. The suction cup according to claim 1, wherein the structure is an overlayer that extends at least partially around the body.

8. The suction cup according to claim 1, wherein the structure is an underlayer and the body extends at least partially around the underlayer.

9. The suction cup according to claim 1, wherein the rim is part of the second portion of the body.

10. The suction cup according to claim 1, comprising an electromechanical vibrator mounted to the body by way of the structure.

11. The suction cup according to claim 1, wherein the body defines a recess and the structure is mated in the recess.

12. The suction cup according to claim 1, wherein the structure comprises a connector part configured to engage with the body to at least partially mount the structure to the body.

13. A suction cup configured to be used in cupping therapy, the suction cup comprising:
a body, wherein at least a portion of the body is elastic and configured so that the body is capable of being squeezed to transition the body from an at-rest configuration to a partially-collapsed configuration, and the body is elastically biased toward the at-rest configuration, wherein volume of an interior space of the suction cup is greater in the at-rest configuration than in the partially-collapsed configuration, and wherein the body comprises:
at least one sidewall extending at least partially around the interior space of the suction cup, and
a rim extending at least partially around an opening to the interior space of the suction cup and configured to be engaged against a user during cupping therapy; and
a stiffener at least partially embedded in the body.

14. The suction cup according to claim 13, wherein:
the stiffener is at least partially embedded in an open end-portion of the body;
the open end-portion of the body includes the rim; and
the stiffener is configured to enhance therapeutic massaging.

15. The suction cup according to claim 13, wherein:
the stiffener is one of a plurality of stiffeners that are at least partially embedded in an open end-portion of the body;
the open end-portion of the body includes the rim; and
the plurality of stiffeners collectively extend at least partially around the interior space of the suction cup.

16. The suction cup according to claim 13, wherein the stiffener is a ball.

17. The suction cup according to claim 13, wherein:
the body comprises an intermediate portion between opposite end portions;
the opposite end portions comprise an open end-portion and a closed end-portion;
the open end-portion comprises the rim and defines the opening; and
the stiffener is positioned in the open end-portion.

18. The suction cup according to claim 13, wherein:
the body comprises an intermediate portion between opposite end portions;
the opposite end portions comprise an open end-portion and a closed end-portion;
the open end-portion comprises the rim and defines the opening; and
the stiffener is positioned in the intermediate portion.

19. The suction cup according to claim 13, wherein:
the body comprises an intermediate portion between opposite end portions;
the opposite end portions comprise an open end-portion and a closed end-portion;
the open end-portion comprises the rim and defines the opening; and
the stiffener is positioned in the closed end-portion.

20. The suction cup according to claim 13, wherein the stiffener extends at least partially around the interior space of the suction cup.

21. The suction cup according to claim 13, wherein:
the stiffener has a length extending along a length of the body; and
the stiffener is configured to transmit vibration along at least a portion of the length of the body.

22. A suction cup configured to be used in cupping therapy, the suction cup comprising:
a body, wherein at least a portion of the body is elastic and configured so that the body is capable of being squeezed to transition the body from an at-rest configuration to a partially-collapsed configuration, and the body is elastically biased toward the at-rest configuration, wherein volume of an interior space of the suction cup is greater in the at-rest configuration than in the partially-collapsed configuration, and wherein the body comprises:
at least one sidewall extending at least partially around the interior space of the suction cup,
a rim extending at least partially around an opening to the interior space of the suction cup and configured to be engaged against a user during cupping therapy, and
a plurality of protrusions, wherein at least some protrusions of the plurality of protrusions extend inwardly into the interior space of the suction cup.

23. A suction cup configured to be used in cupping therapy, the suction cup comprising:
a body, wherein at least a portion of the body is elastic and configured so that the body is capable of being squeezed to transition the body from an at-rest configuration to a partially-collapsed configuration, and the body is elastically biased toward the at-rest configuration, wherein volume of an interior space of the suction cup is greater in the at-rest configuration than in the partially-collapsed configuration, and wherein the body comprises:
at least one sidewall extending at least partially around the interior space of the suction cup, and
a rim extending at least partially around an opening to the interior space of the suction cup and configured to be engaged against a user during cupping therapy; and
an emitter mounted to the body and configured to emit electromagnetic radiation into the interior space of the suction cup so that at least some of the electromagnet radiation emitted into the interior space of the suction cup passes outwardly through the opening to the interior space of the suction cup.
